(19) United States
(12) Patent Application Publication
(10) Pub. No.: US 2025/0084310 A1
(43) Pub. Date: Mar. 13, 2025

(54) POLY(METHYL-DIALLYL AMMONIUM CHLORIDE) DECORATED WITH CATIONIC HYDROPHOBIC PENDANT AS AN ACIDIZING CORROSION INHIBITOR AND METHOD OF PREPARATION THEREOF

(71) Applicant: KING FAHD UNIVERSITY OF PETROLEUM AND MINERALS, Dhahran (SA)

(72) Inventors: Mohammad Abu Jafar MAZUMDER, Dhahran (SA); Shaikh Asrof ALI, Dhahran (SA); Lipiar Khan Mohammad Osman GONI, Dhahran (SA)

(73) Assignee: KING FAHD UNIVERSITY OF PETROLEUM AND MINERALS, Dhahran (SA)

(21) Appl. No.: 18/458,348

(22) Filed: Aug. 30, 2023

(51) Int. Cl. C09K 15/30; C08F 126/04; C09D 5/08; C09D 139/02; C23F 11/04

(52) U.S. Cl. CPC C09K 15/30; C08F 126/04; C09D 5/08; C09D 139/02; C23F 11/04; C08F 2810/00

(57) ABSTRACT

A corrosion inhibitor composition is provided. The corrosion inhibitor composition includes a polycationic polymeric surfactant. The polycationic polymeric surfactant is a copolymer including polymerized units of cationic heterocyclic monomer units and dicationic heterocyclic comonomer units including a quaternary ammonium group. The cationic heterocyclic monomer units and the dicationic heterocyclic comonomer units are alkyl diallyl ammonium units. The quaternary ammonium group comprises a first C8-C16 alkyl group, a second C4-C8 alkyl group, a third C1-C2 alkyl group, and a fourth C1-C2 alkyl group. A method of corrosion inhibition is also provided.

### STATEMENT OF ACKNOWLEDGEMENT

The inventors acknowledge the support provided by the Interdisciplinary Research Center for Advanced Materials, King Fahd University of Petroleum and Materials, Saudi Arabia, through Project INAM 2112.

### BACKGROUND

### Technical Field

The present disclosure is directed to a corrosion inhibitor composition, and particularly to a composition comprising a poly(methyl-diallyl ammonium chloride) copolymer having dicationic comonomer units, and a method of preparation thereof.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

Steel alloys, mainly carbon steel alloys, are frequently utilized in various industrial applications due to their many advantageous characteristics, such as their high mechanical strength, thermal stability, simplicity of production, and low cost. When exposed to an aggressive environment, however, such materials eventually deteriorate through corrosion caused by environmental, chemical, or electrochemical processes. In petroleum and other industries, highly aggressive acidic solutions (15% HCl and 20% H₂SO₄) are widely used for acid cleaning, acid descaling, oil well acidification, and other oil recovery techniques. This causes significant economic and safety issues owing to corrosion. According to a recent NACE report, corrosion costs the world economy more than 2.5 trillion US dollars annually. Due to the rising demand for metallic structures in infrastructures and buildings, corrosion costs are predicted to increase. The replacement and treatment of metal globally comes at a tremendous financial expense. The mining and processing of iron ore necessary to replace millions of tons of steel yearly significantly negatively impacts the environment. There have been numerous attempts to prevent the corrosion of metallic structures in strongly acidic solutions, and one of the most practical and affordable alternatives is the use of organic corrosion inhibitors. Heterocyclic compounds with polar functional groups and π-electrons in double and triple bonds have a high propensity to adsorb on metallic surfaces.

Polymeric chemicals, both of natural and synthetic origin, are increasingly attracting more interest due to their larger macromolecular size providing better surface coverage and protection. By forming complexes with metal ions using their functional groups, polymers cover a substantial surface area of the metal, shielding it from corrosive species in solution. An issue with employing polymers to prevent corrosion is that they are partially soluble in polar electrolytes. Therefore, corrosion experts are developing water-soluble polymer corrosion inhibitors. Polymeric surfactants, highly soluble in water, may be a useful option to suppress corrosion effectively.

The use of organic surfactant inhibitors, many of which are surfactants with hydrophilic and hydrophobic segments, is a common strategy for preventing corrosion. While the hydrophobic portion prefers interactions with other hydrophobic things like hydrocarbons, the hydrophilic group strongly prefers interactions with polar substances, like water, or other ions. Typically, surfactants attached to metal surfaces, restrict the active areas exposed to corrosive fluids, and lessen corrosion attacks. The presence and arrangement of particular atoms, including nitrogen and oxygen, significantly impact the adsorption process and the effectiveness of corrosion inhibition in surfactants. In addition, the corrosion inhibition potential and adsorption behavior of surfactant molecules greatly depend upon the length of hydrocarbon chain(s) (as shown in Table 1 below).

TABLE 1
Summary of literature reports on the effect of alkyl chain length of surfactants as
corrosion inhibitors.

| | | Highest |
|---|---|---|
| | Experimental | efficiency and |
| Chemical Structure & Length of Alkyl Chain | Conditions | concentration |
| 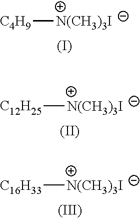 | 0.5M H₂SO₄/ Pure iron | 77% (II)/ 5.22 × 10⁻⁴M |
| 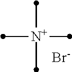 | 0.5M H₂SO₄/ Iron | 38.76% (TMB)/ 5 × 10⁻³M |
| TMB: —CH₃ | | |
| TEB: —C₂H₅ | | |
| TBB: —C₄H₉ | | |
| 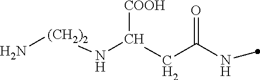 | 2M HCl/Iron | 98.5% (V)/ 0.1% (v/v) |
| I-R: —C₁₄H₂₈; II-R: —C₁₅H₃₁ | | |
| III-R: —C₁₆H₃₃; IV-R: —C₁₇H₃₅ | | |
| V-R: —C₁₈H₃₇ | | |
| 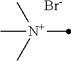 | 0.5M HCl/ carbon steel (CS) | 96.6% (CTAB)/ 8 × 10⁻⁴M |
| C₁₆H₃₃N(CH₃)₃—Br: C₁₆ | | |
| C₁₂H₂₅N(CH₃)₃—Br: C₁₀ | | |
| 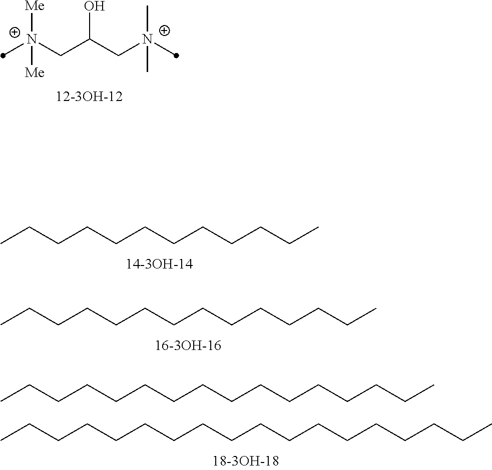 | Brine solution/CS | 95.48% (12-3OH-12) |
| 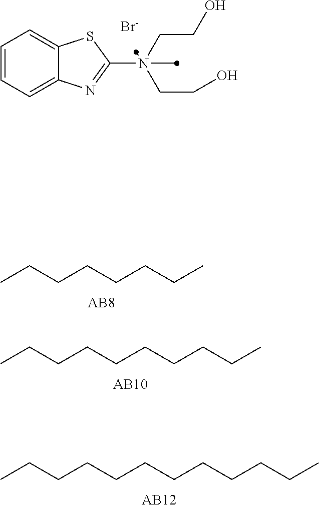 | 1M HCl/CS | 94.35% (AB12)/ 500 ppm |
| 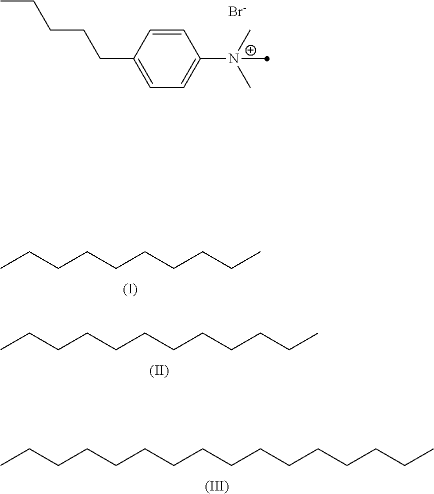 | 1M HCl/CS | 9312% (III)/ 10⁻²M |
| 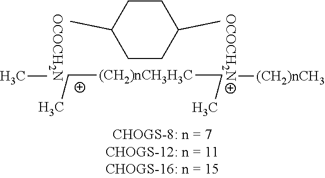 | 15% HCl/CS | 99.21% (CHOGS-16)/ 200 ppm |
| 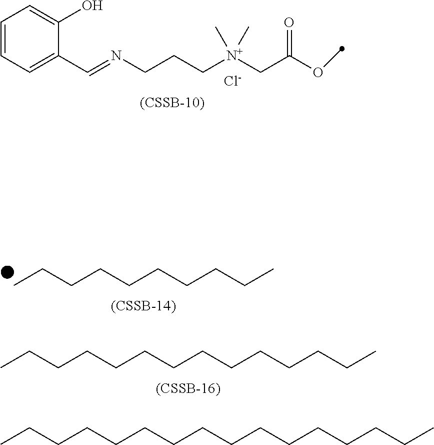 | 3.5% NaCl + 0.5M HCl/CS | 95.52% (CSSB-16)/ 150 ppm |
| 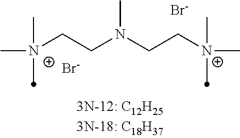 | 3M HCl/ stainless steel (SS) | 92% (3N-18)/ 0.01 mM |
| 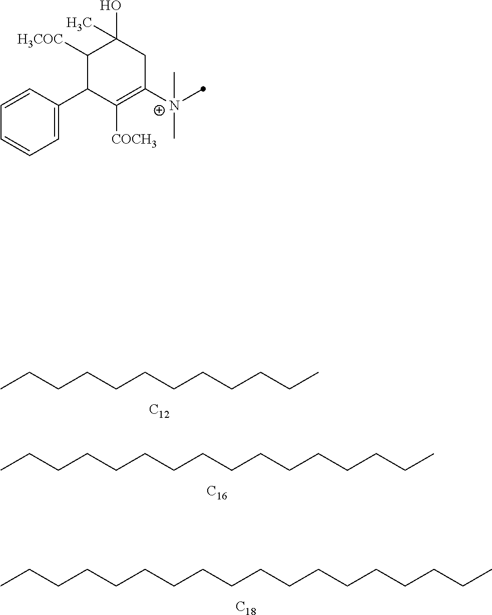 | 15% HCl/C1018 CS | 89.6% at 250 ppm |
| 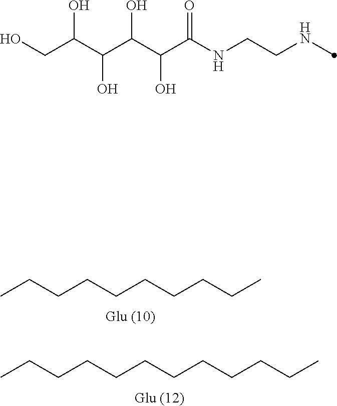 | 3.5% NaCl/mild steel (MS) | 99.1% (Glu12) at 1.25 × 10⁻⁵M |
| 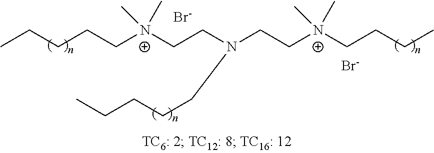 | Formation water/ CS | 91.8% (TC18)/ 300 ppm |
| 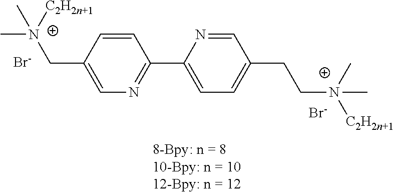 | 1M HCl/CS | 95% (10-Bpy)/ 10⁻⁵M + 0.1M KI |
| 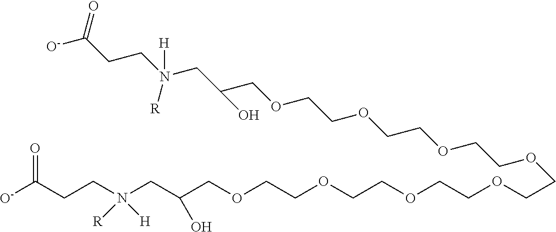 | 1.0M NaCl saturated with CO₂/AISI- 1018 CS | 98.62% (LZW-B16) |
| LZW-B12: C₁₂H₂₅; LZW-B16: C₁₆H₃₃ | | |
| LZW-B12: C₁₈H₃₇ | | |
| 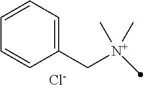 | 0.1%, 1% and 10% NaCl + CO₂/X65 CS | 94% (C16) at 10% v/v |
| C12: C₂₁H₃₈ClN | | |
| C14: C₂₃H₄₂ClN | | |
| C16: C₂₅H₄₆ClN | | |
| 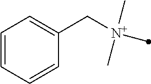 | Mild steel/1% NaCl + CO₂ | Surface coverage conc. (ppm) 200 (Q-C4) |
| Q-C4: —C4H9; Q-C8: —C8H17, | | |
| Q-C12: —C12H25; Q-C16: —C16H33 | | |
| 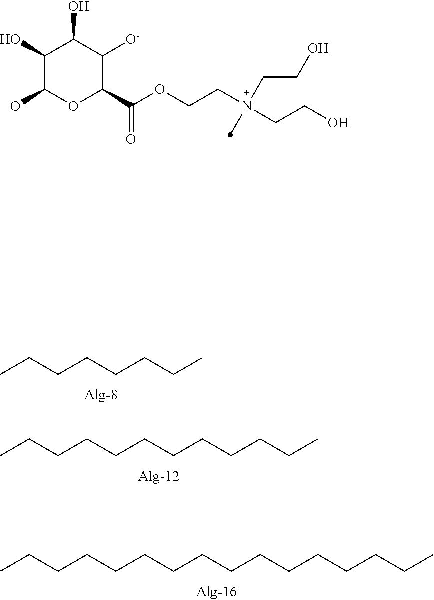 | 1M HCl/MS | 88.9% (Alg-16) at 400 ppm |
| 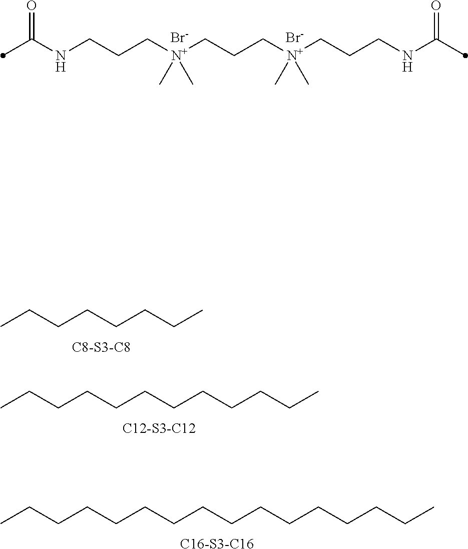 | 1M HCl/MS | 81.6% (C16-S3- C16)/1 × 10⁻³M |
| 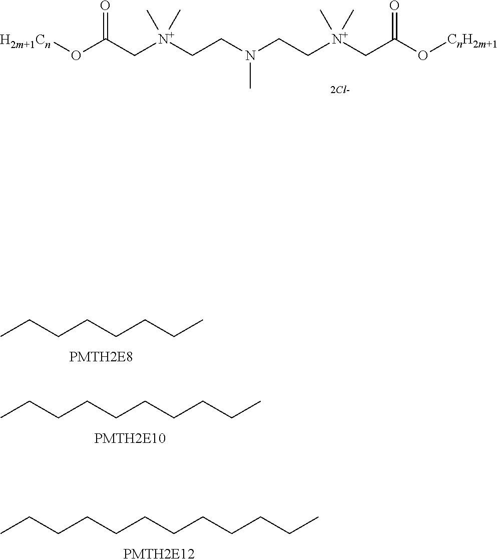 | 3M HC AISI/ 304 SS | 95% (PMTH2E10)/ 2.1 mM |
| 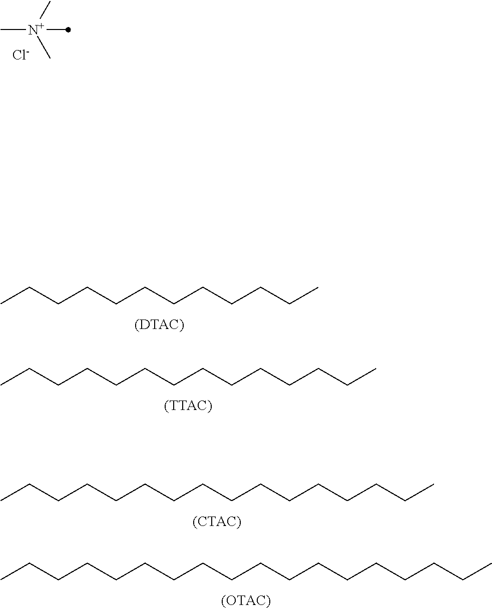 | 5% HCl/A3 steel | 93.31% (DTAC)/ 70 ppm |
| 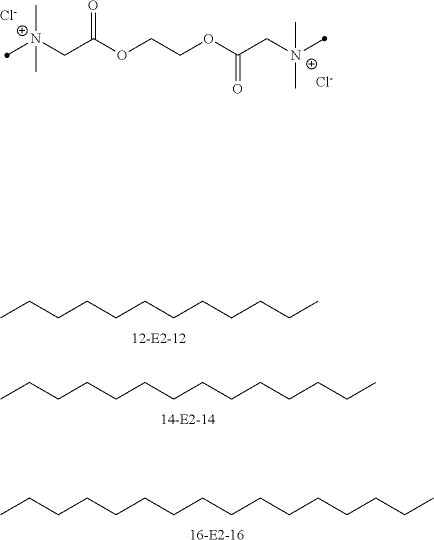 | 1M HCl/MS | 86.6% (16-E2-16) > 81.8% (14- E2-14) > 70.2% (12-E2-12) at 700 ppm |
| 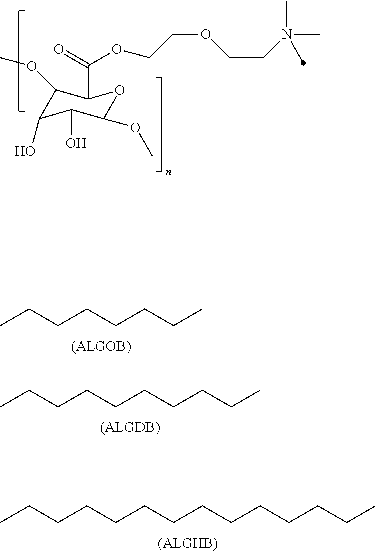 | 1M HCl/MS | 80% (ALGHB)/ 1000 ppm |
| 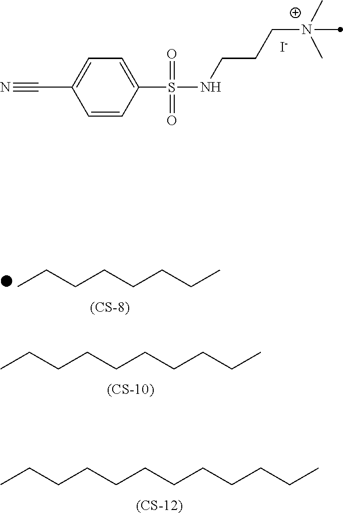 | 3.5% NaCl/ C1018 CS | 99.5% (CS-12)/ 5 × 10⁻⁴M |
| 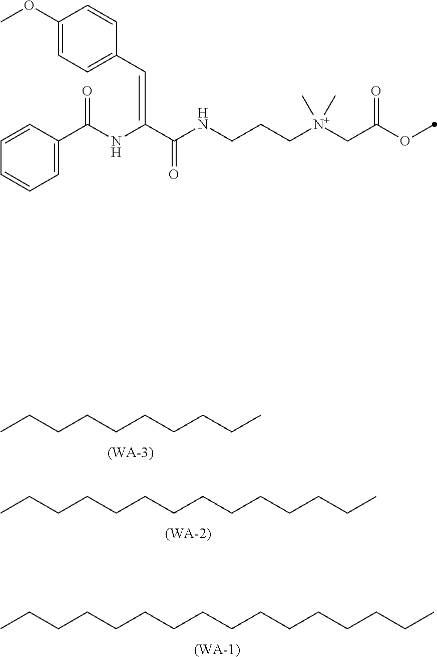 | 1M HCl/CS | 96.6% (WA-1) > 95.4% (WA-2) > 92.4% (WA-3) at 100 ppm |
| 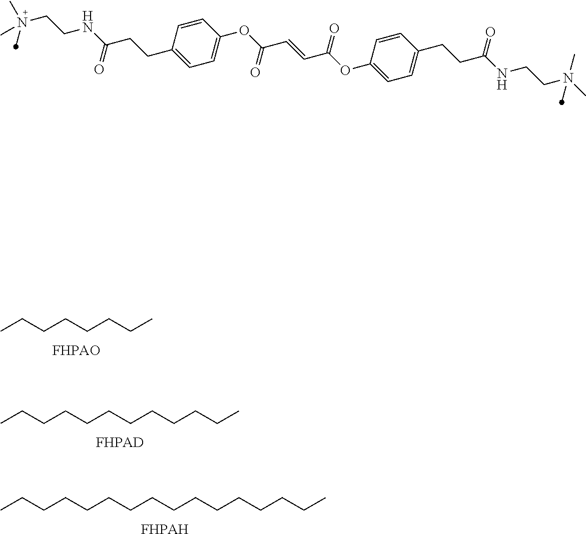 | pH 2/CS | 95.5% (FHPAO)/ 5 mM |
| 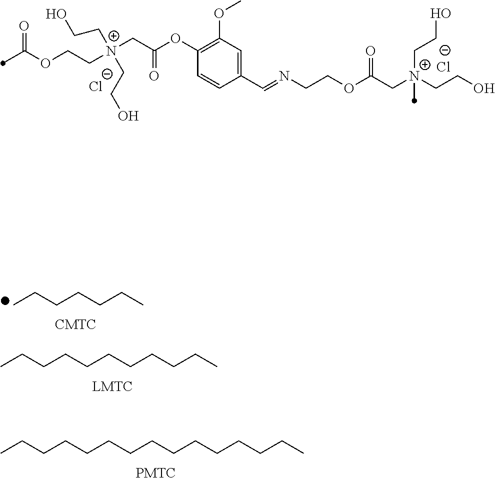 | 1M HCl/CS | 84.59% (PMTC)/ 1000 μM |
| 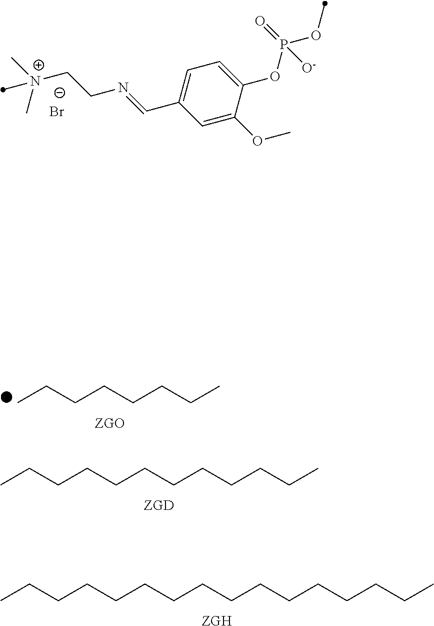 | 1M HCl/CS | 82.06% (ZGH) > 80.08% (ZGD) > 78.10% (ZGO) at 1000 μM |
| 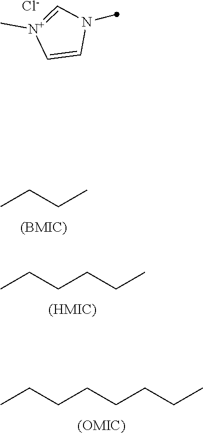 | 1.0M HCl/Al | 94% (OMIC)/ 1 × 10⁻²M |
| 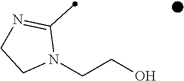 | Computational studies | 96.3% (IC-17) |
| IC-7: —CH₂(CH₂)₅CH₃ | | |
| IC-9: —CH₂(CH₂)₇CH₃ | | |
| IC-11: —CH₂(CH₂)₉CH₃ | | |
| IC-13: —CH₂(CH₂)₁₁CH₃ | | |
| IC-15: —CH₂(CH₂)₁₃CH₃ | | |
| IC-17: —CH₂(CH₂)₁₅CH₃ | | |
| 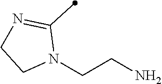 | MD simulations | 99% (E) |
| A: —(CH₂)₆CH₃; B: —(CH₂)₈CH₃ | | |
| C: —(CH₂)₁₀CH₃; D: —(CH₂)₁₂CH₃ | | |
| E: —(CH₂)₁₄CH₃; F: —(CH₂)₁₆CH₃ | | |
| G: —(CH₂)₁₈CH₃; H: —(CH₂)₂₀CH₃ | | |
| 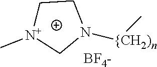 | 1M HCl/MS | 95.4% ([C₁₀MIM] + [BF₄])/500 ppm |
| [EMIM] + [BF₄]−: n = 1 | | |
| [BDMIM] + [BF₄]−: n = 3 | | |
| [C₁₀MIM] + [BF₄]−: n = 9 | | |
| 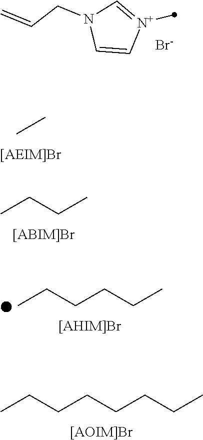 | 0.5M H₂SO₄/Cu | 97.5% ([AOIM]Br)/ 5 mM |
| 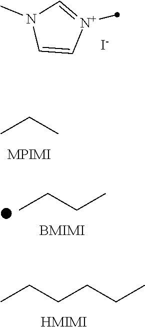 | 1M HCl/CS | 93.1% (HMIMI)/ 5 x 10⁻³M |
| 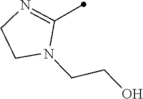 | H₂S acid/CS | 96% (Inh-6) |
| Inhibitor (1): —CH₂(CH₂)₅CH₃ | | |
| Inhibitor (2): —CH₂(CH₂)₇CH₃ | | |
| Inhibitor (3): —CH₂(CH₂)₉CH₃ | | |
| Inhibitor (4): —CH₂(CH₂)₁₁CH₃ | | |
| Inhibitor (5): —CH₂(CH₂)₁₃CH₃ | | |
| Inhibitor (6): —CH₂(CH₂)₁₅CH₃ | | |
| 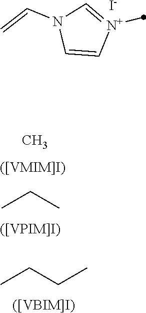 | 0.5M H₂SO₄/ X70 steel | 99.4% ([VBIM]I)/ 5 mM |
| 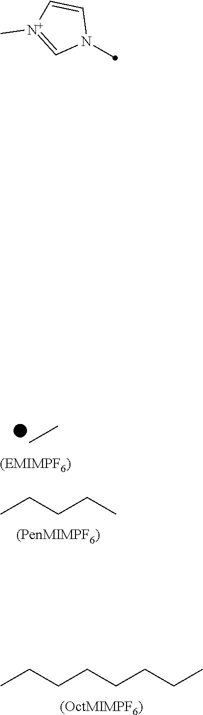 | 1M HCl/CS | 87.60% (PenMIMPF₆)/ 1 × 10⁻³M |
| 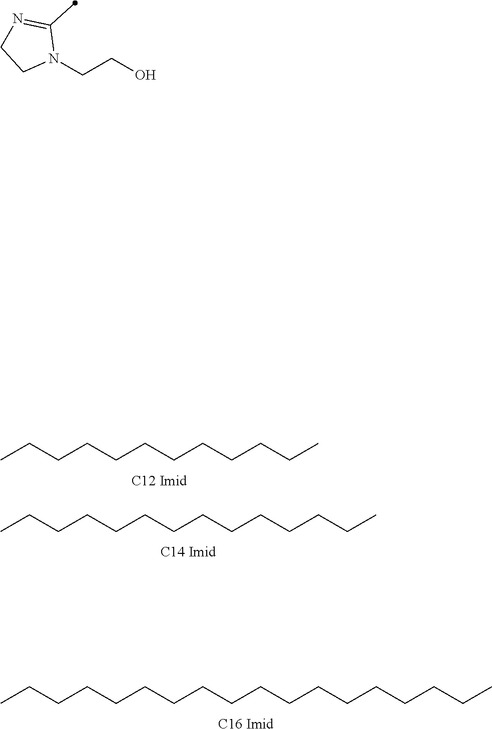 | 0.1%, 1% and 10% NaCl + CO₂/X65 CS | Surface coverage order: C₁₂Imid |
| 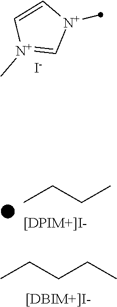 | 1M H₂SO₄/API 5L X52 steel | [DBIM+]I⁻ (93%)/ 0.267 mM |
| 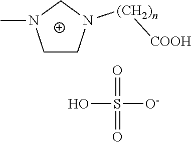 | 0.5M HCl/CS | 93.5% (C) > 85.1 (B) > 52.4% (A) at 15 mM |
| A: n = 1 | | |
| B: n = 2 | | |
| C: n = 3 | | |
| 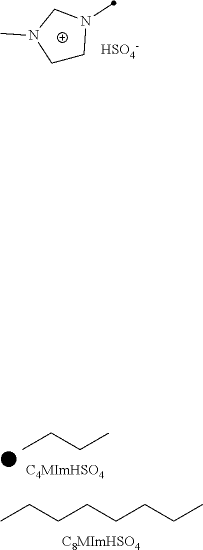 | 1M HCl/MS | 87% (C₈MImHSO₄) > 22% (C₄MImHSO₄) at 10⁻³M |
| 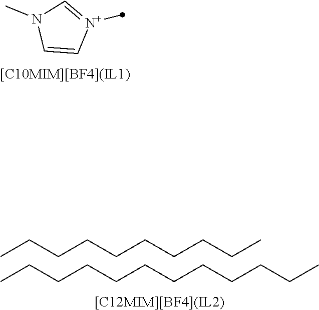 | 1M HCl/CS | [C12MIM] [BF4](IL2) |
| 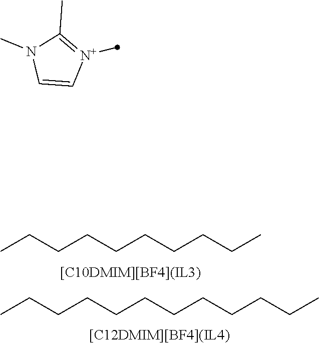 | 1M HCl/CS | [C12DMIM] [BF4](IL4) IL3) |
| 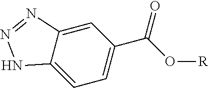 | 0.1M Na₂SO₄/ Cu | 98% (CBTAH—OE)/ 1.5 x 10⁻⁴M |
| CBTAH—ME; CBTAH—BU | | |
| CBTAH—HE; CBTAH—OE | | |
| 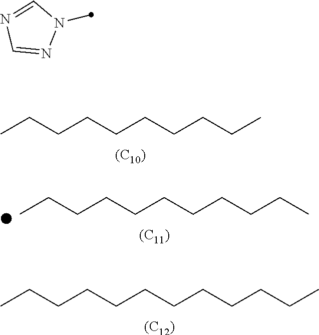 | 1M HCl/Armco iron & Pt | 92% (C12)/ 10⁻²M |
| 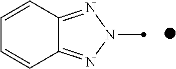 | 1M HCl and H₂SO₄/Aramco iron and Cu | 96% (C₈) |
| BTH: 0; A: C₁; B: C₄ | | |
| C: C₆; D: C₈; E: C₁₂ | | |
| 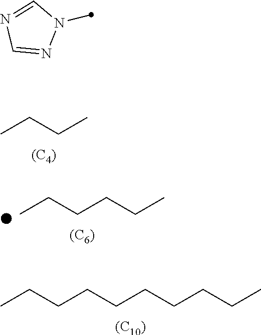 | Computational studies only | III |
| 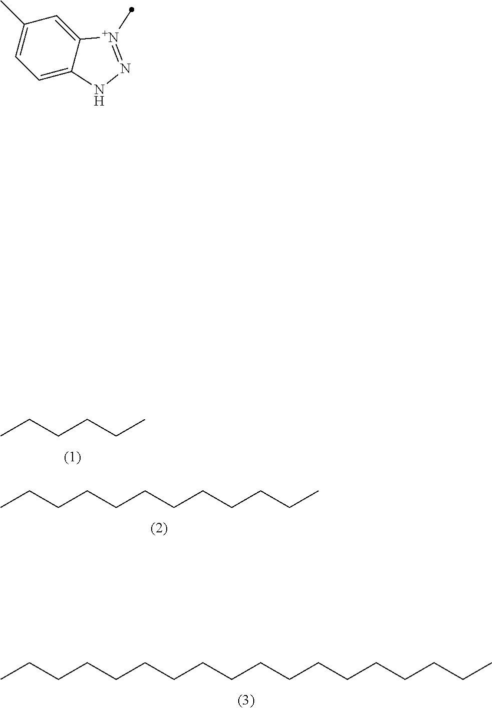 | Copper/seawater | 85.7% (3)/at 1.05 × 10⁻³M |
| 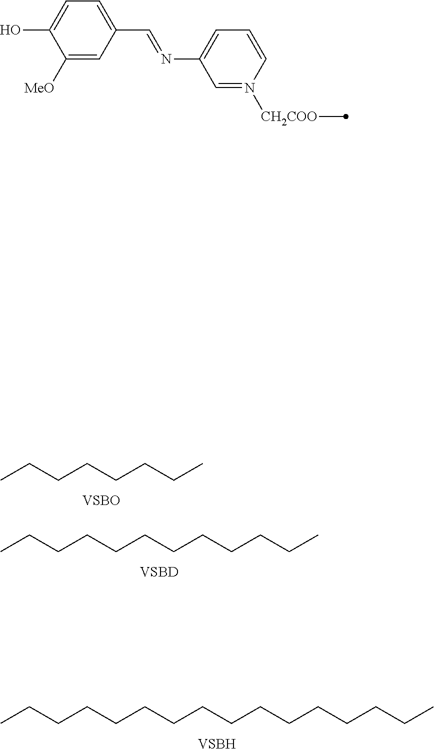 | 1M HCl/CS | 95% (VSBO)/ 400 ppm |
| 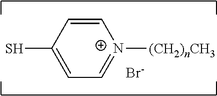 | 1M HCl/CS | 87.68% (III)/ 1 × 10⁻²M |
| I: n = 7; II: n = 9; III: n = 11 | | |
| 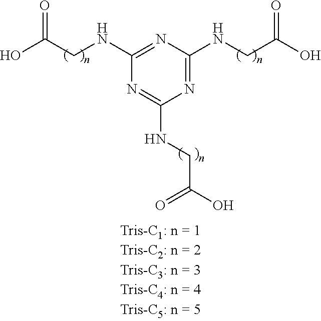 | 1M HCl/MS | 98.38% (Tris-C₅) |
| 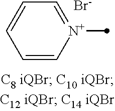 | Steel/0.5M H₂SO₄ | 39% (C₁₀iQBr) > 35% (C₁₂iQBr) > 32% (C₈iQBr) > 3% (C₁₄iQBr) |
| 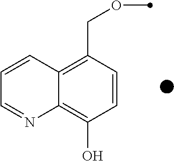 | 1M HCl/CS | 96% (PMHQ)/ 1 × 10⁻³M |
| HMHQ: —H | | |
| MMHQ: —CH₃ | | |
| PMHQ: —C₃H₇ | | |
| 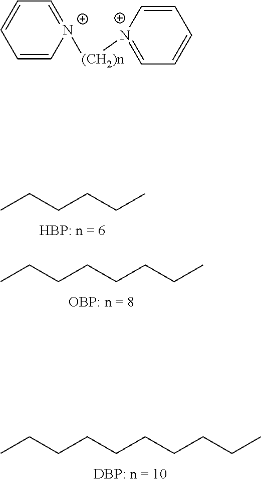 | 1M HCl/P110 steel | 87.9% (DBP)/ 300 ppm |
| 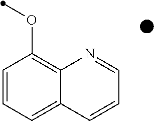 | 1M HCl/MS | 97.5% (QN- C4Br) > 95.7% (QN- C3Br) > 95.2% (QN-C2Br) at 10⁻³M |
| (QN-C2Br): —C₂H₅—Br | | |
| (QN-C3Br): —C₃H₇—Br | | |
| (QN-C4Br): —C₄H₉—Br | | |
| 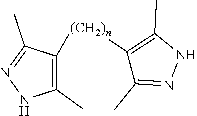 | 1M HCl/Armco iron | 91% (Inh-2)/ 10⁻³M |
| Inh 1: n = 1 | | |
| Inh 2: n = 3 | | |
| Inh 3: n = 5 | | |
| 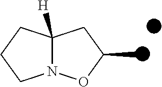 | 1M H₂SO₄/CS | 98.65% (b)/ 400 ppm |
| a; (CH₂)₉CH₃ | | |
| b; (CH₂)₁₃CH₃ | | |
| 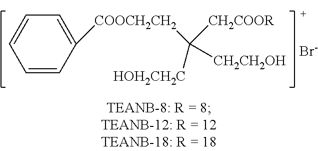 | 2M HCl/MS | 94.29% (TEANB-C8) |
| 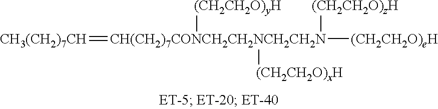 | 1M HCl/API 5L X52 steel | 92.3% (ET-40)/ 0.5 mM |
| 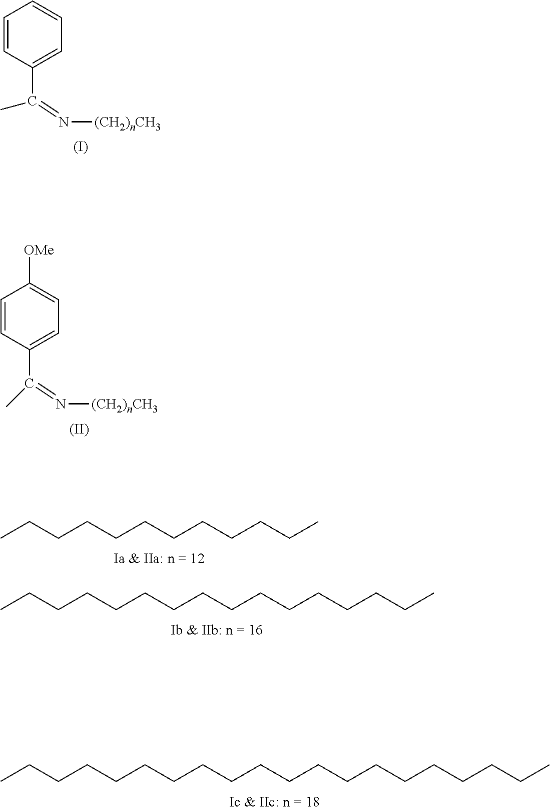 | Mild steel/1M HCl and 1M H₂SO₄ | 99.44% (Ia)/ 200 ppm |
| 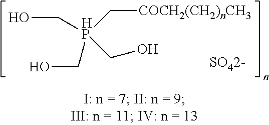 | Carbon steel/ 0.5M HCl | 972.6% (I)/ 800 ppm |
| 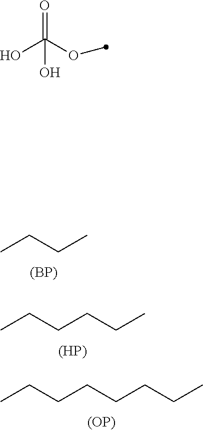 | 0.5M H₂SO₄/ Iron | 96.4% (HP)/ 400 ppm |
| 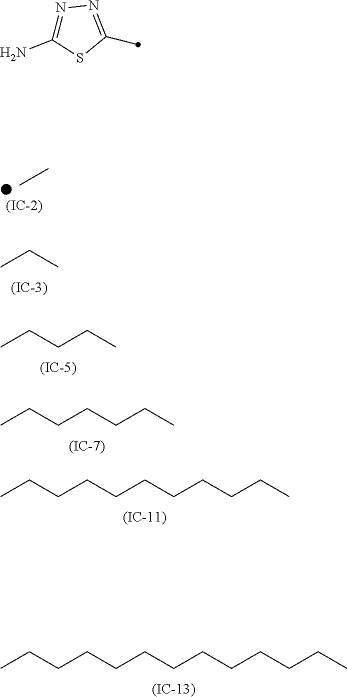 | 1M H₂SO₄/MS | 95% (IC-11) > 86% (IC-7) > 83% (IC-5) > 82% (IC-13) > 81% (IC-3) > 49 (IC-2) at 100 ppm. |
| C3 (Acrylic acid): CH₂═CH—COO— | SCCPS | 92.2% (C11)/ |
| C5 (Allylacetic acid): CH₂═CH—(CH₂)₂—COO— | (pH 11.5)/ | 1000 ppm |
| C7 (6-Heptenoic acid): CH₂═CH—(CH₂)₄—COO— | Q235 CS | |
| C11 (Undecylenic acid): CH2═CH—(CH₂)₈—COO— | | |
| C18 (Oleic acid): CH₃—(CH₂)₇—CH═CH—(CH₂)₇—COO— | | |
| 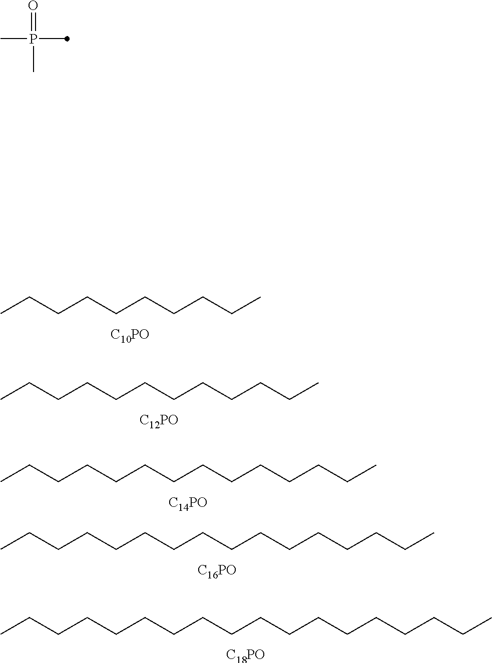 | Formation water/ CS | 94.8% (C18PO)/ 400 ppm |
| 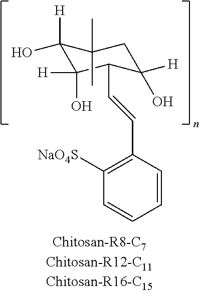 | 1M HCl/CS | 90.37% (Chitosan- R16)/ 800 ppm |
| 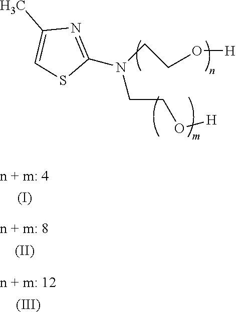 | 15% HCl/X65 steel | 92.2% (n + m = 12)/1 × 10⁻³M |

Although many corrosion inhibitor compositions have been developed in the past, there still exists a need to develop corrosion inhibitor composition with improved corrosion mitigation capability.

Accordingly, an object of the present disclosure is to provide a polycationic polymeric surfactant as a corrosion inhibitor.

### SUMMARY

In an exemplary embodiment, a corrosion inhibitor composition is described. The corrosion inhibitor composition includes a polycationic polymeric surfactant. The polycationic polymeric surfactant is a copolymer including polymerized units of cationic heterocyclic monomer units and dicationic heterocyclic comonomer units comprising a quaternary ammonium group. The quaternary ammonium group comprises a first C8-C16 alkyl group, a second C4-C8 alkyl group, a third C1-C2 alkyl group, and a fourth C1-C2 alkyl group.

In some embodiments, the cationic heterocyclic monomer units and the dicationic heterocyclic comonomer units are present in the copolymer in a molar ratio in a range of 0.85:0.15 to 0.95:0.05.

In some embodiments, the quaternary ammonium group is a dodecyl-dimethyl-hexyl ammonium chloride.

In some embodiments, the polycationic polymeric surfactant has a repeating structure:

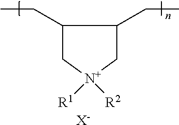

wherein R¹ is a methyl group,
wherein R² is a hydrogen atom or the quaternary ammonium group, and
wherein X is a chloride atom.

In an exemplary embodiment, a method of corrosion inhibition is also described. The method includes contacting a metal substrate with the corrosion inhibitor. The corrosion inhibitor is in the form of a solution comprising the polycationic polymeric surfactant in an amount of 1 to 60 parts per million (ppm) and an acidic aqueous electrolyte to form a corrosion inhibitor coated metal substrate.

In some embodiments, the polycationic polymeric surfactant is in an amount of 5 to 60 ppm and wherein the corrosion inhibitor coated metal substrate has an inhibition efficiency of 65 to 80% based on weight loss of the metal substrate.

In some embodiments, the polycationic polymeric surfactant is in an amount of 5 to 60 ppm and wherein the corrosion inhibitor coated metal substrate has a corrosion rate of 4 to 6 mm yr⁻¹ compared to a corrosion rate of 17 to 19 mm yr⁻¹ of the metal substrate in the absence of the corrosion inhibitor.

In some embodiments, the polycationic polymeric surfactant adsorbs on a surface of the metal substrate via chemisorption.

In some embodiments, the polycation polymeric surfactant is in an amount of 40 to 60 ppm and wherein the corrosion inhibitor coated metal substrate has a corrosion current density of 350 to 450 microamperes per square centimeter (μA cm⁻²) compared to a corrosion current density of 2600 to 2800 μA cm⁻² of the metal substrate in the absence of the corrosion inhibitor.

In some embodiments, the polycation polymeric surfactant is in an amount of 40 to 60 ppm and wherein the corrosion inhibitor coated metal substrate has an elemental composition of iron in the amount of 85 to 88% by weight, oxygen in the amount of 5 to 7% by weight, carbon in the amount of 4 to 6% by weight, chlorine in the amount of 1 to 3% by weight, and manganese 0.5 to 1.5% by weight based on a total weight of the corrosion inhibitor coated metal substrate.

In some embodiments, the polycation polymeric surfactant is in an amount of 40 to 60 ppm and wherein the corrosion inhibitor coated metal substrate has an average surface roughness of 5 to 5.5 micrometers (μm).

In some embodiments, the method further includes adding potassium iodide to the solution.

In some embodiments, the polycationic polymeric surfactant is in an amount of 40 to 60 ppm, wherein a concentration of potassium iodide is 4 to 6 millimolar (mM), and wherein the corrosion inhibitor coated metal substrate has an inhibition efficiency of 92 to 97% based on weight loss of the metal substrate.

In some embodiments, the polycationic polymeric surfactant is in an amount of 40 to 60 ppm, wherein a concentration of potassium iodide is 4 to 6 mM, and wherein the corrosion inhibitor coated metal substrate has a corrosion rate of 0.5 mm yr⁻¹ to 1 mm yr⁻¹ compared to a corrosion rate of 17 to 19 mm yr⁻¹ of the metal substrate in the absence of the corrosion inhibitor and potassium iodide.

In some embodiments, the polycationic polymeric surfactant adsorbs on a surface of the metal substrate using physisorption.

In some embodiments, the polycation polymeric surfactant is in an amount of 40 to 60 ppm, wherein a concentration of potassium iodide is 4 to 6 mM, and wherein the corrosion inhibitor coated metal substrate has a corrosion current density of 15 to 25 μA cm⁻² compared to a corrosion current density of 2600 to 2800 μA cm⁻² of the metal substrate in the absence of the corrosion inhibitor and potassium iodide.

In some embodiments, the polycation polymeric surfactant is in an amount of 40 to 60 ppm, wherein a concentration of potassium iodide is 4 to 6 mM, and wherein the corrosion inhibitor coated metal substrate has an elemental composition of iron in the amount of 88 to 91% by weight, oxygen in the amount of 1 to 3% by weight, carbon in the amount of 5 to 7% by weight, chlorine in the amount of 0.01 to 0.5% by weight, manganese 0.5 to 1.5% by weight, and nitrogen in the amount of 0.5 to 2% by weight based on a total weight of the corrosion inhibitor coated metal substrate.

In some embodiments, the polycation polymeric surfactant is in an amount of 40 to 60 ppm, wherein a concentration of potassium iodide is 4 to 6 mM, and wherein the corrosion inhibitor coated metal substrate has an average surface roughness of 5.5 to 6 μm.

In some embodiments, the metal substrate is C1018 carbon steel.

In some embodiments, the acidic aqueous electrolyte is hydrochloric acid in a concentration of 10 to 20 percent by weight.

These and other aspects of non-limiting embodiments of the present disclosure will become apparent to those skilled in the art upon review of the following description of specific non-limiting embodiments of the disclosure in conjunction with the accompanying drawings. The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure (including alternatives and/or variations thereof) and many of the attendant advantages thereof will be readily obtained as the same becomes better understood by reference to the following detailed description when considered in connection with the accompanying drawings, wherein:

FIG. 1A is a schematic flow chart of a method of corrosion inhibition, according to certain embodiments;

FIG. 1B is a schematic illustration depicting cyclopolymerization of a diallylamine salt and synthesis of cyclopolymer, according to certain embodiments;

FIG. 2A depicts effect of concentrations of a poly(methyl-diallyl ammonium chloride) of the present disclosure (PMDAAC) on inhibition efficiency (IE) for C1018 carbon steel (CS)/15% HCl solution, according to certain embodiments;

FIG. 2B depicts effect of concentration of PMDAAC on corrosion rate (CR) for C1018 CS/15% HCl solution, according to certain embodiments;

FIG. 3A depicts effect of temperature on IE and CR of PMDAAC in the presence of 5 millimolar (mM) of KI, according to certain embodiments;

FIG. 3B depicts effect of temperature on IE and CR of PMDAAC in the absence of 5 mM of KI, according to certain embodiments;

FIG. 4 depicts an Arrhenius plot for C1018 CS corrosion in 15% HCl in the absence of corrosion inhibitor PMDAAC, the presence of corrosion inhibitor PMDAAC, and the presence of corrosion inhibitor PMDAAC+5 mM of KI, according to certain embodiments;

FIG. 5 depicts a Langmuir adsorption isotherm plot for the adsorption of PMDAAC on C1018 CS in 15% HCl, according to certain embodiments;

FIG. 6 depicts a Tafel curve for C1018 CS corrosion in 15% HCl in the absence and presence of PMDAAC and PMDAAC+5 mM KI, according to certain embodiments;

FIG. 7A depicts a Nyquist plot for PMDAAC, according to certain embodiments;

FIG. 7B depicts a Bode magnitude plot for PMDAAC in the presence of 5 mM KI, according to certain embodiments;

FIG. 7C depicts a Nyquist plot for PMDAAC in the presence of 5 mM KI, according to certain embodiments;

FIG. 7D depicts a Nyquist plot for PMDAAC, according to certain embodiments;

FIG. 7E depicts a phase angle plot for PMDAAC in the presence of 5 mM KI, according to certain embodiments;

FIG. 7F depicts a circuit without Warburg impedance, according to certain embodiments;

FIG. 7G depicts a circuit with the Warburg impedance, according to certain embodiments;

FIG. 8A depicts a scanning electron microscopy (SEM) image of polished C1018 CS surface, according to certain embodiments;

FIG. 8B depicts an SEM image of corroded C1018 CS surface in 15% HCl in the absence of PMDAAC, according to certain embodiments;

FIG. 8C depicts an SEM image of corroded C1018 CS surface in 15% HCl in the presence of PMDAAC, according to certain embodiments;

FIG. 8D depicts an SEM image of corroded C1018 CS surface in 15% HCl in the presence of PMDAAC+5 mM KI, according to certain embodiments;

FIG. 9A depicts energy dispersive X-ray spectrometry (EDX) mapping of polished C1018 CS surface, according to certain embodiments;

FIG. 9B depicts EDX spectra of polished C1018 CS surface, according to certain embodiments;

FIG. 9C depicts EDX mapping of corroded C1018 CS surface in 15% HCl in the absence of PMDAAC, according to certain embodiments;

FIG. 9D depicts EDX spectra of corroded C1018 CS surface in 15% HCl in the absence of PMDAAC, according to certain embodiments;

FIG. 9E depicts EDX mapping of corroded C1018 CS surface in 15% HCl in the presence of PMDAAC, according to certain embodiments;

FIG. 9F depicts EDX spectra of corroded C1018 CS surface in 15% HCl in the presence of PMDAAC, according to certain embodiments;

FIG. 9G depicts EDX mapping of corroded C1018 CS surface in 15% HCl in the presence of PMDAAC+5 mM KI, according to certain embodiments

FIG. 9H depicts EDX spectra of corroded C1018 CS surface in 15% HCl in the presence of PMDAAC+5 mM KI, according to certain embodiments;

FIG. 10A depicts set 1 of two-dimensional (2D) and three-dimensional (3D) atomic force microscopy (AFM) images of polished C1018 CS surface, according to certain embodiments;

FIG. 10B depicts set 1 of 2D and 3D AFM images of corroded C1018 CS surface in 15% HCl in the absence of PMDAAC, according to certain embodiments;

FIG. 10C depicts set 1 of 2D and 3D AFM images of corroded C1018 CS surface in 15% HCl in the presence of 50 parts per million (ppm) PMDAAC, according to certain embodiments;

FIG. 10D depicts set 1 of 2D and 3D AFM images of corroded C1018 CS surface in 15% HCl in the presence of 50 ppm PMDAAC+5 mM KI, according to certain embodiments;

FIG. 11A depicts set 2 of 2D and 3D AFM images of polished C1018 CS surface, according to certain embodiments;

FIG. 11B depicts set 2 of 2D and 3D AFM images of corroded C1018 CS surface in 15% HCl in the absence of PMDAAC, according to certain embodiments;

FIG. 11C depicts set 2 of 2D and 3D AFM images of corroded C1018 CS surface in 15% HCl in the presence of 50 ppm PMDAAC, according to certain embodiments;

FIG. 11D depicts set 2 of 2D and 3D AFM images of corroded C1018 CS surface in 15% HCl in the presence of 50 ppm PMDAAC+5 mM KI, according to certain embodiments;

FIG. 12A depicts set 3 of 2D and 3D AFM images of polished C1018 CS surface, according to certain embodiments;

FIG. 12B depicts set 3 of 2D and 3D AFM images of corroded C1018 CS surface in 15% HCl in the absence of PMDAAC, according to certain embodiments;

FIG. 12C depicts set 3 of 2D and 3D AFM images of corroded C1018 CS surface in 15% HCl in the presence of 50 ppm PMDAAC, according to certain embodiments;

FIG. 12D depicts set 3 of 2D and 3D AFM images of corroded C1018 CS surface in 15% HCl in the presence of 50 ppm PMDAAC+5 mM KI, according to certain embodiments;

FIG. 13A depicts AFM images indices of set 1 of polished C1018 CS surface, according to certain embodiments;

FIG. 13B depicts AFM images indices of set 2 of polished C1018 CS surface, according to certain embodiments;

FIG. 13C depicts AFM images indices of set 3 of polished C1018 CS surface, according to certain embodiments;

FIG. 13D depicts AFM images indices of set 1 of corroded C1018 CS surface in 15% HCl in the absence of PMDAAC, according to certain embodiments;

FIG. 13E depicts AFM images indices of set 2 of corroded C1018 CS surface in 15% HCl in the absence of PMDAAC, according to certain embodiments;

FIG. 13F depicts AFM images indices of set 3 of corroded C1018 CS surface in 15% HCl in the absence of PMDAAC, according to certain embodiments;

FIG. 13G depicts AFM images indices of set 1 of corroded C1018 CS surface in 15% HCl in the presence of 50 ppm PMDAAC, according to certain embodiments;

FIG. 13H depicts AFM images indices of set 2 of corroded C1018 CS surface in 15% HCl in the presence of 50 ppm PMDAAC, according to certain embodiments;

FIG. 13I depicts AFM images indices of set 3 of corroded C1018 CS surface in 15% HCl in the presence of 50 ppm PMDAAC, according to certain embodiments;

FIG. 13J depicts AFM images indices of set 1 of corroded C1018 CS surface in 15% HCl in the presence of 50 ppm PMDAAC+5 mM KI, according to certain embodiments;

FIG. 13K depicts AFM images indices of set 2 of corroded C1018 CS surface in 15% HCl in the presence of 50 ppm PMDAAC+5 mM KI, according to certain embodiments;

FIG. 13L depicts AFM images indices of set 3 of corroded C1018 CS surface in 15% HCl in the presence of 50 ppm PMDAAC+5 mM KI, according to certain embodiments;

FIG. 14 depicts fragment molecular orbital (FMO) (optimized, highest occupied molecular orbital (HOMO), and lowest occupied molecular orbital (LUMO)) pictures of chemical species derived through B3LYP functional and G-31G (d, p) basis set, according to certain embodiments;

FIG. 15 depicts a schematic mechanism of deprotonation of pyrrolidinium nitrogen having one hydrogen in an aqueous solution of HCl containing PMDAAC, according to certain embodiments; and

FIG. 16 depicts a schematic bonding and adsorption mode of PMDAAC on C1018 CS surface in 15% HCl solution, according to certain embodiments.

### DETAILED DESCRIPTION

In the following description, it is understood that other embodiments may be utilized, and structural and operational changes may be made without departure from the scope of the present embodiments disclosed herein.

Reference will now be made in detail to specific embodiments or features, examples of which are illustrated in the accompanying drawings. Whenever possible, corresponding, or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may be construed to relate to the plural and vice-versa without limiting the scope of the disclosure to the exact number or type of such elements unless set forth explicitly in the appended claims. In the drawings, like reference numerals designate identical or corresponding parts throughout the several views. Further, as used herein, the words “a,” “an” and the like include plural referents, unless stated otherwise.

Furthermore, the terms “approximately,” “approximate,” “about,” and similar terms generally refer to ranges that include the identified value within a margin of 20%, 10%, or preferably 5%, and any values there between.

As used herein, the term “surfactant” refers to a chemical compound that decreases the surface tension or interfacial tension between two liquids, a liquid and a gas, or a liquid and a solid. In an embodiment, the surfactant may refer to an organic compound that, when added to a surface, changes the properties of that surface. In an embodiment, the surfactant may function as an emulsifier, a wetting agent, a detergent, a foaming agent, a dispersant, a combination thereof, and the like. In some embodiments, the surfactant may be ionic, nonionic, amphiphilic, and the like. In an embodiment, a surfactant molecule may include one or more hydrophilic units attached to one or more hydrophobic units. The hydrophobic unit of the surfactant may include a hydrocarbon chain, which can be branched, linear, aromatic, or a combination thereof. In some embodiments, the one or more hydrophilic units may be a hydrophilic head. In some embodiments, the one or more hydrophobic units may be a hydrophobic tail. In some embodiments, surfactant may be added to an aqueous phase and the surfactants may form aggregates, such as spherical micelles, cylindrical micelles, lipid bilayers, and the like. Aggregate shape and size may be influenced by the chemical composition, structure, and amount of the surfactant. Fluorosurfactants have fluorocarbon chains. Siloxane surfactants have siloxane chains. Gemini surfactant molecules are dimeric structures and include two or more hydrophilic units and two or more hydrophobic units. In some embodiments, surfactants may include a polyether chain terminating in a polar anionic group. Polar anionic groups may include, but are not limited to, a carboxylic acid salt group, a sulfonic acid salt group, an alcohol sulfate group, an alkylbenzene sulfonate group, a phosphoric acid salt group, a phosphoric ester group, and the like. The polyether groups may include ethoxylated (polyethylene oxide-like) sequences inserted to increase the hydrophilic character of a surfactant. In other embodiments, polypropylene oxides may be inserted to increase the lipophilic character of a surfactant.

Surfactants may include a polar cationic group. Cationic surfactants have cationic functional groups, such as primary, secondary, tertiary, and quaternary amines. Cationic surfactant functional groups may include, but are not limited to, ammonium, sulfonium, phosphonium, and the like. Cationic surfactants may include, but are not limited to, octenidine dihydrochloride; cetrimonium bromide (CTAB), cetylpyridinium chloride (CPC), benzalkonium chloride (BAC), benzethonium chloride (BZT), dimethyl-dioctadecyl ammonium chloride, dioctadecyl-dimethyl ammonium bromide (DODAB), and any cationic surfactant known in the art.

As used herein, the term “surface aggregation concentration” (SAC or SATC) refers to the surfactant concentration at which a monolayer of surfactant molecules adsorbs on and covers a metal surface. In some embodiments, one or more layers of surfactant molecules may adsorb on and cover the metal surface.

As used herein, the term “synergism” refers to a tendency for one or more of a first compound and one or more of a second compound to have a combined effect greater than cumulative individual effects of the one or more first compound and the one or more second compound.

According to an aspect of the present disclosure, a corrosion inhibitor is described. As used herein, the term “corrosion inhibitor or anti-corrosive” refers to a chemical compound that, when added to a liquid or gas, or deposited onto a corrodible surface, decreases the corrosion rate of a material, typically a metal or an alloy, in contact with the liquid or gas. The effectiveness of a corrosion inhibitor depends on liquid and/or gas composition, quantity of water, flow regime, and the like. A mechanism of inhibiting corrosion may involve a formation of a coating, sometimes referred to as a passivation layer, which prevents access of a corrosive substance to the material. The passivation layer may be a liquid or a gas. The passivation layer refers to coating a material so that it becomes less readily affected or corroded by the environment. Passivation may involve creation of an outer layer of a shield material that is applied as a microcoating, created by a chemical reaction with the base material, or allowed to build by spontaneous oxidation in the air. For example, passivation may use a light coat of a protective material, such as a metal oxide, to create a shield against corrosion.

According to an aspect of the present disclosure, a poly(methyl-diallyl ammonium chloride) (PMDAAC) polymer surfactant containing dicationic comonomer units is tested as an acidizing corrosion inhibitor for C1018 carbon steel/15% HCl system. Weight loss tests of the C1018 carbon steel show that PMDAAC manifests 76.57% inhibition efficiency (% IE) at 50 parts per million (ppm) based on an initial mass of the C1018 carbon steel. The presence of 5 millimolar (mM) KI increases the % IE of PMDAAC from 76.57% to 95.26%. The increase in % IE from 85.33% to 99.28% and 83.28 to 98.42% was also observed in the presence of 5 mM KI using potentiodynamic polarization (PDP) and electrochemical impedance spectroscopy (EIS) studies, respectively.

The corrosion inhibitor is based on a polycationic polymeric surfactant, preferably poly(methyl-diallyl ammonium chloride). As used herein, the term “polymeric surfactant” is a surfactant that has a polymer both for a head group and a tail group. As used herein, the term “polycationic” is a material that has at least two positively charged groups. The polycationic polymeric surfactant is a copolymer including polymerized units of cationic heterocyclic monomer units and dicationic heterocyclic comonomer units having a quaternary ammonium group. The quaternary ammonium group comprises a first C8-C16 alkyl group, a second C4-C8 alkyl group, a third C1-C2 alkyl group, and a fourth C1-C2 alkyl group. The cationic heterocyclic monomer units and dicationic heterocyclic comonomer units are present in the copolymer in a molar ratio in a range of 0.50:0.50 to 0.99:0.01, preferably 0.75:0.25 to 0.98:0.02, more preferably 0.85:0.15 to 0.95:0.05, preferably about 0.90:0.10. The polycationic polymeric surfactant has a repeating structure of cationic heterocyclic monomer units:

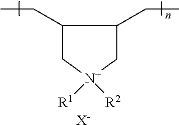

where R¹ is an alkyl group such as a methyl, ethyl, propyl, butyl, or pentyl group, R² is a hydrogen atom (or a quaternary ammonium group in the case of the dicationic heterocyclic comonomer units), and X is a counter ion such as a chloride, bromide, or iodide atom. The quaternary ammonium group comprises a first C8-C16, preferably C10-C14, and more preferably C12 alkyl group. The quaternary ammonium group comprises a second C4-C8, preferably C5-C7, and more preferably C6 alkyl group. The quaternary ammonium group comprises a third C1-C2, preferably C1 alkyl group. The quaternary ammonium group comprises and a fourth C1-C2, preferably C1 alkyl group. The first and second groups of the quaternary ammonium group may be linear, branched, aromatic, substituted, or a combination thereof. The quaternary ammonium group may have a chloride, bromide, iodide, carbonate, nitrate, sulfate, counterion, or a combination thereof. In a preferred embodiment, the counter ion is chloride. In a preferred embodiment, the quaternary ammonium group is a dodecyl-dimethyl-hexyl ammonium salt. The quaternary ammonium group may have other alkyl groups such as methyl, ethyl, butyl, hexyl, octyl, dodecyl, benzyl methyl, benzyl ethyl, phenyl methyl, phenyl ethyl, dimethyl alkyl benzyl, methyl alkyl benzyl, trialkyl benzyl, where the alkyl group may have about 1 to about 16 carbon atoms, about 4 and about 16 carbon atoms, or about 6 to about 16 carbon atoms, a combination thereof, and the like.

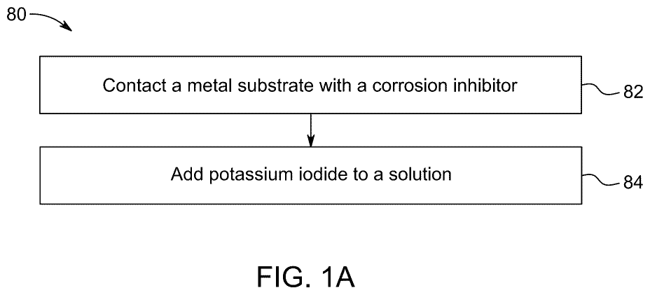

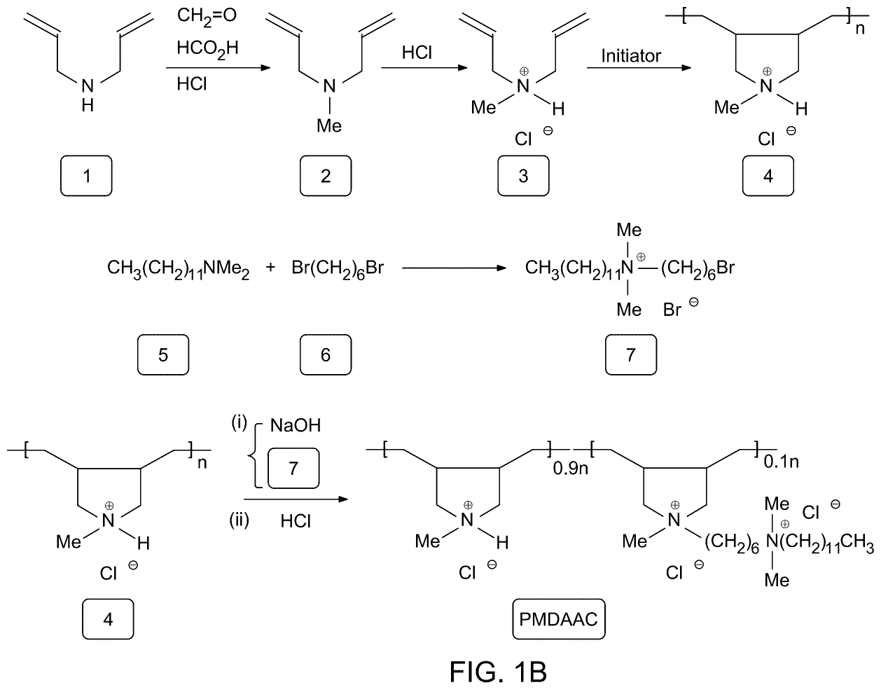

FIG. 1 illustrates a flow chart of a method 80 of corrosion inhibition. The order in which the method 80 is described is not intended to be construed as a limitation, and any number of the described method steps can be combined in any order to implement the method 80. Additionally, individual steps may be removed or skipped from the method 80 without departing from the spirit and scope of the present disclosure.

At step 82, the method 80 includes contacting a metal substrate with a corrosion inhibitor and/or corrosion inhibitor composition. In a preferred embodiment, the metal substrate is C1018 carbon steel (CS). In some embodiments, the metal substrate may include aluminum, copper, zinc, alloys, steel, galvanized steel, and the like. The corrosion inhibitor is in the form of a solution including the polycationic polymeric surfactant in an amount of 1 to 200 ppm, preferably 1 to 100 ppm, preferably 1 to 60 ppm, more preferably 5 to 50 ppm, and yet more preferably about 50 ppm and an acidic aqueous electrolyte to form a corrosion inhibitor-coated metal substrate. The acidic aqueous electrolyte is hydrochloric acid in a concentration of 1 to 50% percent by weight, preferably 5 to 25% percent by weight, more preferably 10 to 20% percent by weight, and yet more preferably about 15% percent by weight. In some embodiments, the hydrochloric acid can be substituted by nitric acid, hydrofluoric acid, citric acid, formic acid, acetic acid, a mixture thereof, or any acid known in the art. In some embodiments, when the polycationic polymeric surfactant is in an amount of 1 to 200 ppm, preferably 1 to 100 ppm, preferably 1 to 60 ppm, more preferably 5 to 50 ppm, and yet more preferably about 50 ppm, the corrosion inhibitor coated metal substrate has an inhibition efficiency of 50 to 90%, preferably 60 to 85%, more preferably 65 to 80%, and yet more preferably 76 to 77% based on weight loss of the metal substrate (see for example: https://www.astm.org/mpc20170001.html, https://www.astm.org/stp43971s.html, and any of these https://www.astm.org/catalogsearch/result/?q=acid+corrosion). In some embodiments, when the polycationic polymeric surfactant is in an amount of 1 to 200 ppm, preferably 1 to 100 ppm, preferably 1 to 60 ppm, more preferably 5 to 50 ppm, and yet more preferably about 50 ppm, the corrosion inhibitor-coated metal substrate has a corrosion rate of 1 to 10 mean annual (mm yr⁻¹), preferably 2 to 8 mm yr⁻¹, and more preferably 4 to 7 mm compared to a corrosion rate of 17 to 19 mm yr⁻¹ of the metal substrate in the absence of the corrosion inhibitor. As used herein, the term “corrosion rate” refers to the speed at which any metal in a specific environment deteriorates. A corrosion rate may define an amount of corrosion loss per year in thickness.

The adsorption of the polycationic polymeric surfactant on the surface of the metal substrate may be via chemisorption or physisorption. Chemisorption is a form of adsorption in which adsorbed material is held together by chemical bonds. The adsorption involves a chemical reaction between a surface and an adsorbate where new chemical bonds are generated at the adsorbent surface. Chemisorption on solid materials is achieved by a sharing of electrons between the surface of the adsorbent and adsorbate to create a covalent or ionic bond. Physisorption is a method which preserves the electronic structure of an atom or molecule throughout the adsorption process. Physisorption uses an interacting force of van der Waals attraction through induced, permanent, or transient electric dipoles and the like. In some embodiments, the polycationic polymeric surfactant adsorbs on the surface of the metal substrate using isothermal adsorption techniques. When the polycation polymeric surfactant is in an amount of 40 to 60 ppm, preferably about 50 ppm, the corrosion inhibitor-coated metal substrate has a corrosion current density of 300 to 800 microamperes per square centimeter (μA cm⁻²), preferably 300 to 500 μA cm⁻², more preferably 350 to 450 μA cm⁻², and yet more preferably about 400 μA cm⁻², compared to a corrosion current density of 2600 to 2800 μA cm⁻², preferably about 2700 μA cm⁻², of the metal substrate in the absence of the corrosion inhibitor.

In some embodiments, when the polycation polymeric surfactant is in an amount of 40 to 60 ppm, preferably about 50 ppm, the corrosion inhibitor coated metal substrate has an elemental composition of iron in the amount of 85 to 88% by weight, oxygen in the amount of 5 to 7% by weight, carbon in the amount of 4 to 6% by weight, chlorine in the amount of 1 to 3% by weight, and manganese 0.5 to 1.5% by weight based on a total weight of the corrosion inhibitor coated metal substrate. In some embodiments, when the polycation polymeric surfactant is in an amount of 40 to 60 ppm, preferably about 50 ppm, the corrosion inhibitor coated metal substrate has an average surface roughness of 5 to 5.5 micrometers (μm), preferably about 5.3 μm.

At step 84, the method 80 may optionally include adding potassium iodide to a solution. In some embodiments, when the concentration of the polycationic polymeric surfactant is in an amount of 40 to 60 ppm, preferably about 50 ppm, and the concentration of potassium iodide is 4 to 6 mM, preferably about 5 mM, the corrosion inhibitor coated metal substrate has an inhibition efficiency of 90 to 99%, preferably 92 to 97%, more preferably 94 to 96%, and yet more preferably about 95% based on weight loss of the metal substrate. In some embodiments, when the concentration of the polycationic polymeric surfactant is in an amount of 40 to 60 ppm, preferably about 50 ppm, and the concentration of potassium iodide is 4 to 6 mM, preferably about 5 mM, the corrosion inhibitor coated metal substrate has a corrosion rate of 0.1 to 3 mm yr⁻¹, preferably 0.4 to 2 mm yr⁻¹, more preferably 0.7 to 1 mm yr⁻¹, and yet more preferably about 0.85 mm yr⁻¹ compared to a corrosion rate of 17 to 19 mm yr⁻¹ of the metal substrate in the absence of the corrosion inhibitor and potassium iodide.

In some embodiments, when the concentration of the polycationic polymeric surfactant is in an amount of 40 to 60 ppm, preferably about 50 ppm, and the concentration of potassium iodide is 4 to 6 mM, preferably about 5 mM, the corrosion inhibitor-coated metal substrate has a corrosion current density of 15 to 25 μA cm⁻², more preferably 18 to 20 μA cm⁻², and yet more preferably about 19.40 μA cm⁻², compared to a corrosion current density of 2600 to 2800 μA cm⁻², more preferably 2700 μA cm⁻², of the metal substrate in the absence of the corrosion inhibitor and potassium iodide.

In some embodiments, when the concentration of the polycationic polymeric surfactant is in an amount of 40 to 60 ppm, preferably about 50 ppm, and the concentration of potassium iodide is 4 to 6 mM, preferably about 5 mM, the corrosion inhibitor-coated metal substrate has an elemental composition of iron in the amount of 88 to 91% by weight, oxygen in the amount of 1 to 3% by weight, carbon in the amount of 5 to 7% by weight, chlorine in the amount of 0.01 to 0.5% by weight, manganese 0.5 to 1.5% by weight, and nitrogen in the amount of 0.5 to 2% by weight based on a total weight of the corrosion inhibitor coated metal substrate. In some embodiments, when the concentration of the polycationic polymeric surfactant is in an amount of to 60 ppm, preferably about 50 ppm, and the concentration of potassium iodide is 4 to 6 mM, preferably about 5 mM, the corrosion inhibitor coated metal substrate has an average surface roughness of 5.5 to 6 μm, preferably about 5.9 μm.

### EXAMPLES

The following examples describe and demonstrate exemplary embodiments of the corrosion inhibitor as described herein. The examples are provided solely for the purpose of illustration and are not to be construed as limitations of the present disclosure, as many variations thereof are possible without departing from the spirit and scope of the present disclosure.

### Example 1: Materials

Diallylamine, sodium hydroxide and ammonium persulfate (APS) were acquired from Sigma-Aldrich and utilized as directed. Dialysis was performed using Spectrum Laboratories Inc.'s Spectra/Por membrane (MWCO: 3500 & 6-8000 Da). 1,6-dibromohexane, concentrated HCl (37%), acetonitrile, acetone, methanol, toluene, and potassium iodide (KI) were obtained from Fluka Chemie AG and used as received. The reaction between diallylamine (1), paraformaldehyde and formic acid produced methyldiallylamine (2), as provided in FIG. 1B. A detailed description of the synthesis (FIG. 1B) and characterization of poly(methyl-diallyl ammonium chloride) (PMDAAC) has been described (C. Verma, et. al., 2023, Synthesis of Polymeric Surfactant Containing Bis-cationic Motifs as a Highly Efficient acid Corrosion Inhibitor for C1018 Carbon steel (CS), New Journal of Chemistry, incorporated herein by reference in its entirety). The test electrolyte was a 15% HCl solution, while the working electrode, material for chemical, electrochemical, and surface studies were C1018 carbon steel (CS).

### Example 2: Methods

For experiments, C1018 CS was used. The C1018 CS composition (in weight percent) was Mn 0.75, C 0.18, S 0.05, P 0.04, and Fe (balance). The weight loss method was initially used to study PMDAAC's potential to guard against C1018 CS corrosion in 15% HCl because of its degree of precision, degree of reproducibility, and simplicity. C1018 CS specimens with a particular dimension that had been cleaned, dried, and weighed were submerged in 15% HCl without and with various concentrations of PMDAAC for three hours. Different grit sizes of silicon carbide (#120, #180, #400, #800, and #1200) were utilized for surface cleaning. After the allocated time, the samples were taken out, cleaned with distilled water and acetone, dried in a moisture-free desiccator, and weighed again. Each experiment was tripled to ensure the reproducibility of the weight loss results, and mean values were presented for each concentration. The cleaning and preparation of samples for weight loss, electrochemical, and surface analyses is described in S. H. Pine, The Eschweiler-Clark methylation of amines: An organic chemistry experiment, Journal of Chemical Education, 45 (1968) 118, incorporated herein by reference in its entirety, and I. Y. Yaagoob, S. A. Ali, H. A. Al-Muallem, M. A. Mazumder, Scope of sulfur dioxide incorporation into alkyldiallylamine-maleic acid-SO₂ tercyclopolymer, Rsc Advances, 8 (2018) 38891-38902, incorporated herein by reference in its entirety. The inhibition efficiency (% IE) was determined using the observed average weight loss as follows [N. A. Odewunmi, M. A. Mazumder, S. A. Ali, Tipping Effect of Tetra-alkylammonium on the Potency of N-(6-(1H-benzo[d]imidazol-1-yl) hexyl)-N, N-dimethyldodecan-1-aminium bromide (BIDAB) as Corrosion Inhibitor of Austenitic 304L Stainless Steel in Oil and Gas Acidization: Experimental and DFT Approach, Journal of Molecular Liquids, (2022) 119431, incorporated herein by reference in its entirety; D. S. Chauhan, M. A. Quraishi, M. A. J. Mazumder, S. A. Ali, N. A. Aljeaban, B. G. Alharbi, Design and synthesis of a novel corrosion inhibitor embedded with quaternary ammonium, amide and amine motifs for protection of carbon steel in 1 M HCl, Journal of Molecular Liquids, 317 (2020) 113917, incorporated herein by reference in its entirety]:

$$\% IE = \frac{{W}_{0} - {W}_{inh}}{{W}_{0}} \times 100 \qquad ( 1 )$$

where, Wᵢₙₕ and W₀ represent the weight losses in the presence and absence of various investigated polymer concentrations, respectively.

Electrochemical tests at various concentrations of PMDAAC with and without KI were conducted to show the electrochemical nature of PMDAAC. A Galvanostat/Potentiostat (Model G-300) (manufactured by Gamry, 734 Louis Drive, Warminster, PA 18974 USA) was used for the electrochemical experiments. Data analysis and fitting were performed using Echem 5.0 software tool, which calculates electrochemical indices. The assembly's working, reference, and counter electrodes are C1018 CS, calomel electrode, and cylindrical graphite rod, respectively. A C1018 CS exposure area of 1 square centimeter (cm²) was chosen for all electrochemical tests. Electrochemical impedance spectroscopy (EIS) investigations were conducted at a constant amplitude of 10 millivolts (mV) over a frequency range of 10 megahertz (MHz) to 100 kilohertz (kHz). The % IE of PMDAAC at various concentrations was determined using EIS and potentiodynamic polarization (PDP) techniques, respectively, and then calculated using equations (2) and (3). The values of R_{ct} (charge transfer resistance) and i_{corr} (corrosion current density) were calculated by fitting Nyquist curves in an appropriate equivalent circuit and extrapolating the linear portions of Tafel curves, respectively.

$$\% IE = \frac{{R}_{ct}^{i} - {R}_{ct}^{0}}{{R}_{ct}^{i}} \times 100 \qquad ( 2 )$$

$$\% IE = \frac{{i}_{corr}^{0} - {i}_{corr}^{i}}{{i}_{corr}^{0}} \times 100 \qquad ( 3 )$$

The superscripts “i” and “0” signify that PMDAAC is present (“i”) or absent (“0”) in the test electrolyte. ESCALAB™-250Xi (manufactured by ThermoFisher™, Waltham, Massachusetts, United States) is implanted with monochromatic Al K radiation (hv=1486.6 eV), and Quattro ESEM-FEG (energy dispersive X-ray spectrometry (EDX), Oxford Instruments) (manufactured by ThermoFisher™, Waltham, Massachusetts, United States) was used to test the surface immunity of C1018 CS coupons with dimensions of 1 cm×1 cm×1 cm.

Polished samples were washed and rinsed with ethanol and acetone to remove any last-minute oil, moisture, or polishing residues. The C1018 CS polished coupons were immersed entirely, with and without adding 50 ppm PMDAAC, in a 15% HCl solution at 30° C. After three hours, the C1018 CS polished coupons were taken out of the corrosive medium, dried with cold stream air at room temperature, and then submitted for examination by scanning electron microscopy (SEM) and EDX spectroscopy to determine the surface shape and elemental composition. The surface roughness of the C1018 CS surface corroded in the presence and absence of a pre-determined concentration of PMDAAC (50 ppm) with and without 5 millimolar (mM) KI was measured using a 3D optical profilometer (Contour GT-K, Bruker Nano GmBH, Germany). Density functional theory (DFT)-based computational investigations were carried out for the building blocks of PMDAAC, samples 4 and 7 as observed in FIG. 1B, and PMDAAC to determine the mechanism of corrosion prevention and the molecular locations responsible for interacting with the metallic surface. One repeating unit was chosen for the DFT calculations. The Becke 3-parameter hybrid functional and the Lee-Yang-Paar correlation functional, also known as B3LYP, were selected for the experiment. 6-31+G was the basis set used for all calculations (d,p). The molecular locations sharing charges with the metallic substrate were described using the frontier molecular orbital (FMO) images of samples 4, 7, and PMDAAC.

### Weight Loss Studies

Due to its ease of use and high reliability, the gravimetric method was used to examine the impact of various PMDAAC concentrations on the inhibition efficiency (% IE) of C1018 CS in 15% HCl. Table 2 displays several parameters derived from the weight loss study.

TABLE 2
Weight loss parameters for C1018 CS corrosion in 15% HCl with and
without PMDAAC in the absence and presence of 5 mM KI
at 30° C.

| | | Weight | | Surface | |
|---|---|---|---|---|---|
| | Conc. | loss | CR | coverage | |
| Sample | (ppm) | (mg) | (mm y⁻¹) | (θ) | (%) IE |
| PMDAAC | 0 | 109.7 | 18.2 | — | — |
| | 2 | 40.4 | 6.7 | 0.6317 | 63.17 |
| | 5 | 33.5 | 5.56 | 0.6946 | 69.46 |
| | 10 | 32.9 | 5.46 | 0.7 | 70 |
| | 20 | 31.6 | 5.24 | 0.7384 | 73.84 |
| | 50 | 25.7 | 4.26 | 0.7657 | 76.57 |
| | 50 + | 5.2 | 0.86 | 0.9526 | 95.26 |
| | 5 mM KI | | | | |

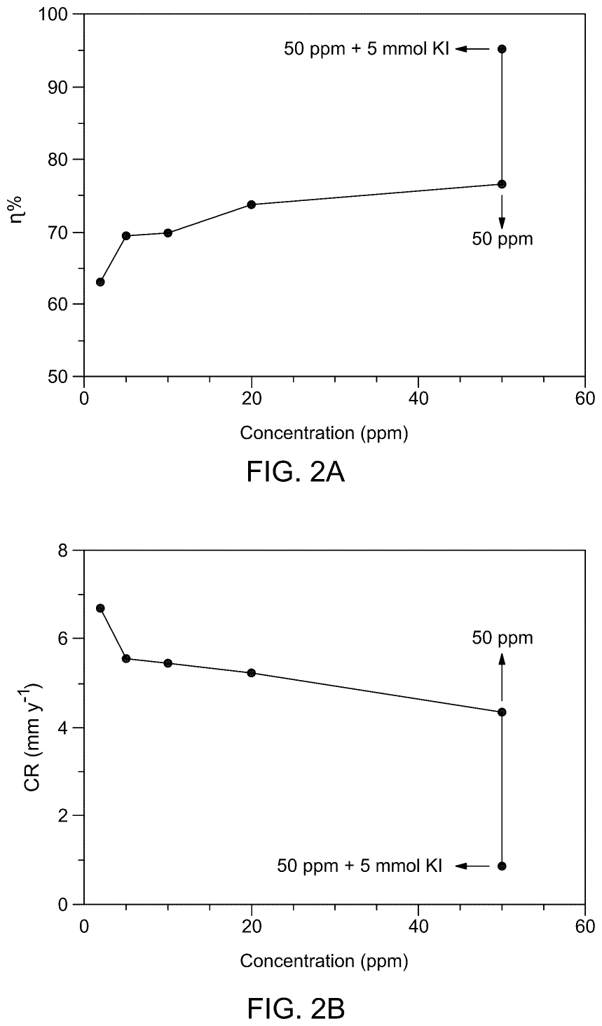

The results reveal that the PMDAAC's protective effectiveness increases with increasing concentrations. At 10, 20, and 50 ppm concentrations, the PMDAAC displays % IE of 70.00%, 73.84%, and 76.57%, respectively. To realize the synergistic effects of KI, a study was conducted where 2, 5, and 10 mM of KI was added to the 50 ppm PMDAAC, and inhibition efficiencies were found to be 93.53%, 95.26%, and 96.17%, respectively. The presence of 5 mM of KI causes an increase in % IE from 76.57% to 95.26% (FIG. 2A). The effectiveness of PMDAAC's inhibition slightly improved with further increasing the concentration of KI. Therefore, 5 mM of KI was used to investigate the synergistic effects of PMDAAC and KI. It is generally known that an increase in inhibitor concentration results in an increase in surface covering, which raises the % IE. Furthermore, it was observed that at lower concentrations, inhibitors preferentially adsorb in a flat orientation, increasing the surface coverage. The inhibitor molecules, however, adsorb perpendicularly onto the metallic surface if the concentration of the inhibitor is increased beyond a particular value because of electrostatic repulsion between the molecules at greater concentrations.

The kind and extent of the metallic surface's charge are factors that affect the mechanism of adsorption of organic corrosion inhibitors in aqueous electrolytes. Most often, the adsorption of water molecules and/or the buildup of the electrolyte's counter ions causes metal surfaces to develop a negative charge. In contrast, the organic corrosion inhibitors have a positive charge because of their cationic nature (cationic surfactants) or protonation of the heteroatoms. In most investigations, the first stage of metal-inhibitor interactions involves attracting two oppositely charged entities through physisorption. Halide ions increase the negative charge character of metallic surfaces, favor physisorption, and accelerate the rate of % IE. The effect of PMDAAC and PMDAAC+5 mM KI concentrations on corrosion rate (mm y⁻¹) and % IE for C1018 CS corrosion in 15% HCl are presented in FIG. 2B. According to the finding, the corrosion rate gradually lowers as PMDAAC concentration increases and abruptly decreases in the presence of 5 mM KI.

TABLE 3
The effect of temperature (303-333 K.) on corrosion inhibition
potential of PMDAAC (50 ppm) for C1018 CS in 15% HCl
with and without 5 mM KI.

| | PMDAAC | | PMDAAC | |
|---|---|---|---|---|
| | (50 ppm) | | (50 ppm) + KI (5 mM) | |
| | % | CR | % | CR |
| Temperature (K.) | IE | (mm y⁻¹) | IE | (mm y⁻¹) |
| 303 | 76.57 | 4.26 | 95.26 | 0.86 |
| 313 | 74.1 | 10.32 | 96 | 1.84 |
| 323 | 82.11 | 7.83 | 96.1 | 3.6 |
| 333 | 81.06 | 17.21 | 96.75 | 6.02 |

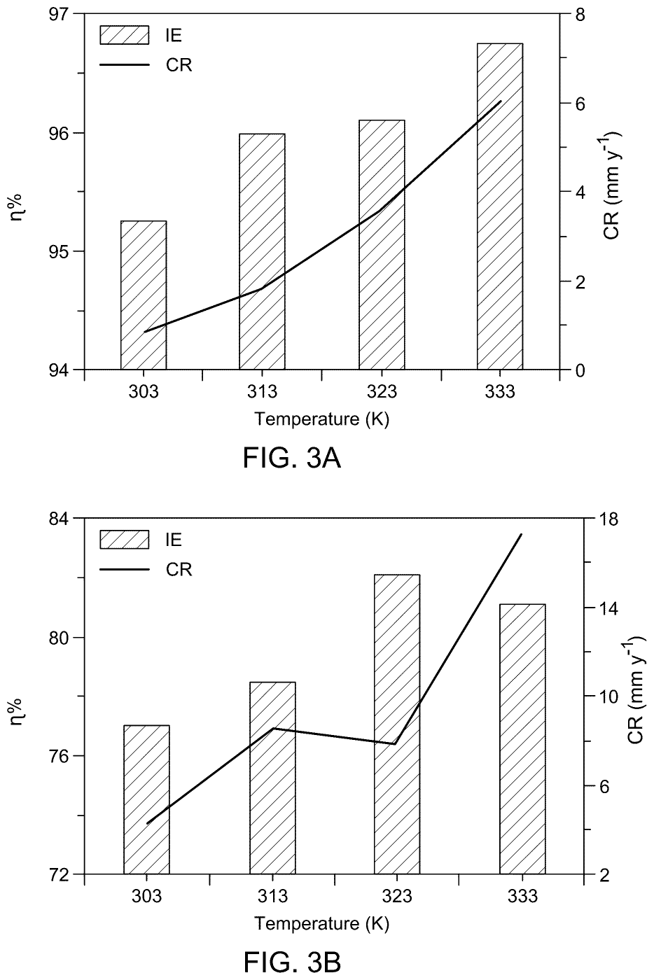

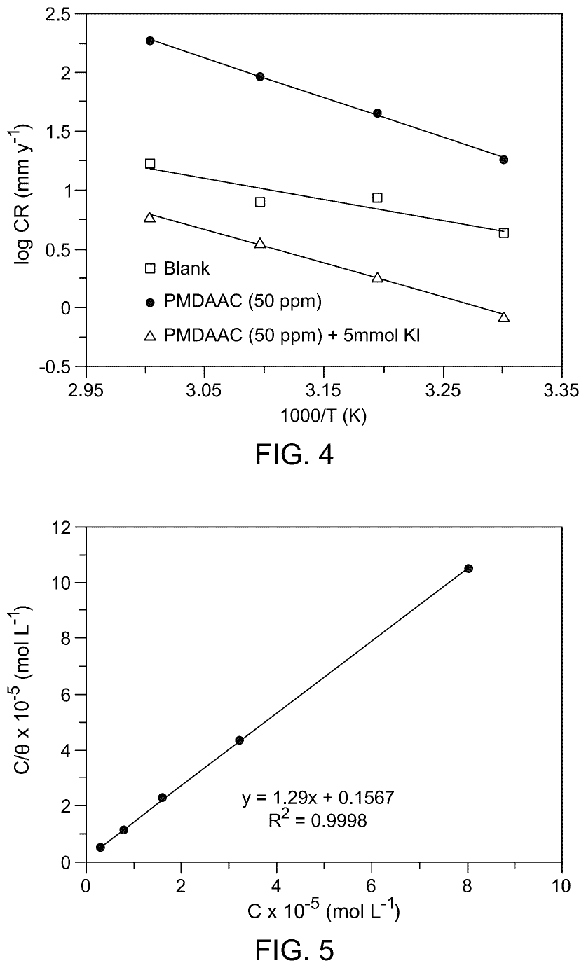

Table 3 and FIG. 3A and FIG. 3B represent the effect of temperature (303-333 K) on the corrosion inhibition potential of PMDAAC (50 ppm) for C1018 CS in 15% HCl with and without 5 mM of KI. The data in Table 3 indicates that the influence of temperature is not exceptionally reliable. It appears that an increase in temperature has a favorable impact on the % IE of PMDAAC both in the absence and presence of KI. This result implies that an increase in temperature benefits PMDAAC's capacity to adsorb under both conditions. A mechanism of chemisorption supports this type of activity [D. Quy Huong et. al., Effect of the structure and temperature on corrosion inhibition of thiourea derivatives in 1.0 M HCl solutions, ACS omega, 4 (2019) 14478-14489, incorporated herein by reference in its entirety]. The effect of temperature on the corrosion inhibition potential of PMDAAC and PMDAAC+5 mM KI can be presented using the Arrhenius relationship shown in equation (4). The Arrhenius plots for C1018 CS corrosion in 15% HCl with and without PMDAAC and PMDAAC+5 mM KI are illustrated in FIG. 4. The activation energy (Eₐ) values for C1018 CS corrosion in 15% HCl were 64.31, 32.84, and 54.63 kilojoules per mole (kJ mol⁻¹) for blank, PMDAAC, and PMDAAC+5 mM KI, respectively. The lower values of Eₐ inhibited by PMDAAC and PMDAAC+5 mM KI might be attributed to a chemisorption mode. Further, a higher value of Eₐ for PMDAAC+5 mM KI as compared to PMDAAC indicates that the presence of KI favors physisorption.

$$log {C}_{R} = \frac{- {E}_{a}}{- 2.3 \; 03 RT} + log A \qquad ( 4 )$$

where, C_{R} (gram per centimeter square per hour (g cm⁻² h⁻¹)), A, R, and T represent corrosion rate, Arrhenius pre-exponential factor, gas constant, and absolute temperature, respectively.

Corrosion inhibitors prevent metallic corrosion in acid solutions by adhering to the surface. As it gives structural information on the double layer in addition to thermodynamic information, the study of the adsorption properties of inhibitor molecules on metallic surfaces is a crucial component of corrosion inhibition research. By fitting experimental surface coverage data into various adsorption isotherms (equations 5-7), it was possible to study the adsorption of the researched PMDAAC on the C1018 CS surface. According to values close to the unity of the measured regression coefficient (R²), the Langmuir adsorption isotherm provided the best fit.

TABLE 4
Adsorption isotherm parameters for the adsorption of PMDAAC on C1018 CS
in 15% HCl solution.

| | | | | | | | Langmuir | | |
|---|---|---|---|---|---|---|---|---|---|
| | Temkin | | Frumkin | | Freundlich | | | K_{ads} | ΔGºads |
| Sample | R² | f | R² | a | R² | n | R² | (L mol⁻¹) | (kJ mol⁻¹) |
| PMDAAC | 0.9568 | 24.98 | 0.937 | −10.19 | 0.9478 | 0.06 | 0.9998 | 6.37 × 10⁵ | −43.76 |

Table 4 represents the R² values of different tested isotherm models and different indices of the Langmuir isotherm for the adsorption of PMDAAC on the C1018 CS surface in 15% HCl.

$$Langmuir isotherm \text{:} θ / ( 1 - θ ) = {K}_{ads} C \qquad ( 5 )$$

$$Temkin isotherm \text{:} {K}_{ads} C = {e}^{f θ} \qquad ( 6 )$$

$$Freundluich isotherm \text{:} θ = {K}_{ads} {C}^{n} \qquad ( 7 )$$

Theta (θ) denotes surface coverage, C represents the concentration of the corrosion inhibitor PMDAAC, K_{ads} denotes the adsorption and desorption constant, and f and n, respectively, denote the Temkin and Freundlich adsorbate characteristics. The K_{ads} value for the adsorption of PMDAAC on the C1018 CS surface was derived from the intercept of the Langmuir isotherm plot (FIG. 5) and served as the basis for the calculation of standard Gibbs free energy (AG ads) for the PMDAAC adsorption as per the following relationship:

$$Δ {G}_{ads}^{0} = - RT ln ( 55.5 {K}_{ads} ) \qquad ( 8 )$$

A high K_{ads} value (6.37×10⁵ liter per mole (L mol⁻¹)) and a low ΔG°_{ads} value (−43.76 kJ mol⁻¹) show that PMDAAC has a spontaneous propensity to chemisorb on C10181 CS surface in test electrolyte.

### Electrochemical Studies

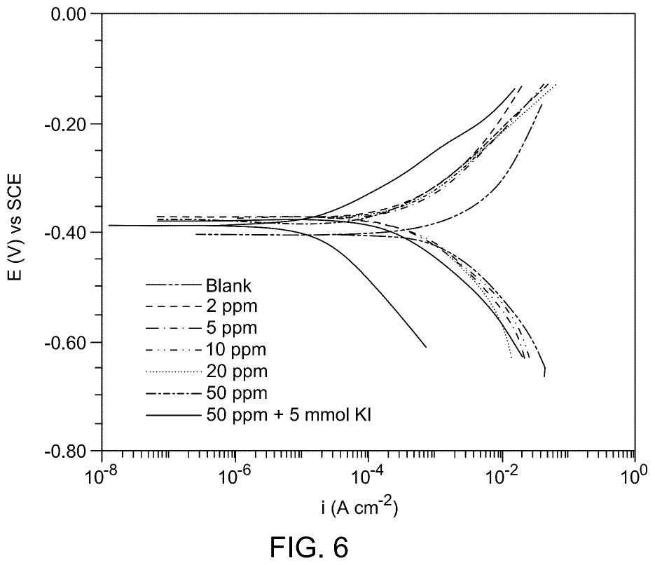

The PDP investigation was conducted to learn more about the kinetics of the Tafel reactions of C1018 CS dissolution in a 15% HCl solution. The anodic and cathodic Tafel curves for C1018 CS corrosion in 15% HCl are represented in FIG. 6. It is seen that the anodic and cathodic processes, in the presence of PMDAAC and PMDAAC+5 mM KI, shift toward lower currents in comparison to the Tafel slopes of the blank specimen. Therefore, it is supported that the presence of PMDAAC+5 mM KI influences both the cathodic hydrogen evolution and the anodic C1018 CS dissolution. The drop in anodic and cathodic current densities was more pronounced at higher inhibitor (PMDAAC) concentrations. To obtain polarization parameters, such as current density (i_{corr}), corrosion potential (E_{corr}), anodic slope (βₐ), and cathodic slope (β_{c}), the linear segments of the anodic and cathodic Tafel curves were extrapolated. These parameters, along with efficiency η_{PDP %} are presented in Table 5.

TABLE 5
Polarization parameters for C1018 CS corrosion in 15% HCl in the absence and
presence of PMDAAC and PMDAAC + 5 mM KI at 30° C.

| | PDP | | | | | LPR | |
|---|---|---|---|---|---|---|---|
| | E_{corr} | βₐ | −β_{c} | I_{corr} | η_{PDP} | Rₚ | |
| Conc. (ppm) | (mV) | (mV dec⁻¹) | (mV dec⁻¹) | (μA cm⁻²) | (%) | (Ω cm²) | % IE |
| 0 | −399.0 | 114.4 | 159.0 | 2700 | — | 16.10 | — |
| 2 | −372.0 | 104.1 | 119.5 | 721.0 | 73.30 | 56.85 | 71.67 |
| 5 | −376.0 | 123.7 | 128.6 | 618.0 | 77.11 | 60.49 | 73.38 |
| 10 | −376.0 | 156.1 | 112.5 | 580.0 | 78.52 | 67.34 | 76.09 |
| 20 | −379.0 | 132.5 | 110.9 | 485.0 | 82.04 | 90.38 | 82.19 |
| 50 | −378.0 | 237.5 | 132.9 | 396.0 | 85.33 | 98.72 | 83.69 |
| 50 + 5 mM KI | −377.0 | 69.1 | 120.0 | 19.40 | 99.28 | 1047 | 98.46 |

The data is shown to demonstrate that the presence of PMDAAC and PMDAAC+5 mM KI has a considerable impact on the anodic, cathodic, and total current densities. This finding suggests that PMDAAC and PMDAAC+5 mM KI work by adsorbing and inhibiting the active sites that cause corrosive damage. The i_{corr} value of 2700 μA cm⁻² for free acid corrosion of C1018 CS decreased to 396.0 μA cm⁻² and 19.40 μA cm⁻² in the presence of PMDAAC and PMDAAC+5 mM KI, respectively. A corrosion inhibitor is typically categorized as a particular type based on the change in the E_{corr} value relative to the blank. The inhibitor is classified as a mixed-type inhibitor if the difference in the E_{corr} is smaller than 85 mV with respect to the E_{corr} of the blank. In the present disclosure, the shift in E_{corr} values was less than 85 mV; therefore, PMDAAC and PMDAAC+5 mM KI are classified as mixed-type corrosion inhibitors. The PDP and LPR data were consistent with the outcomes of the weight loss study.

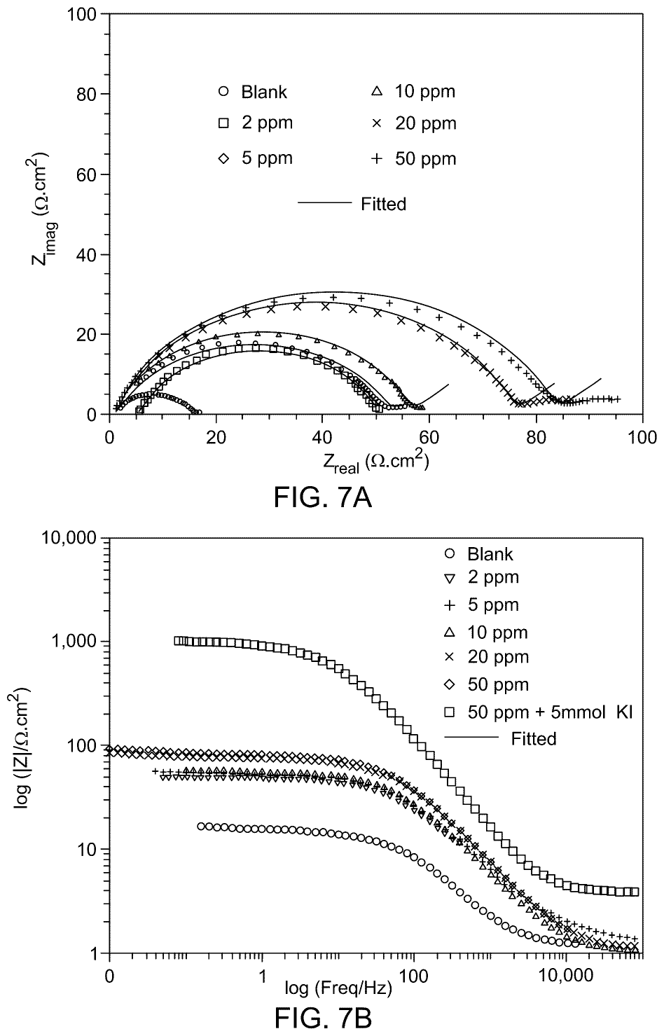

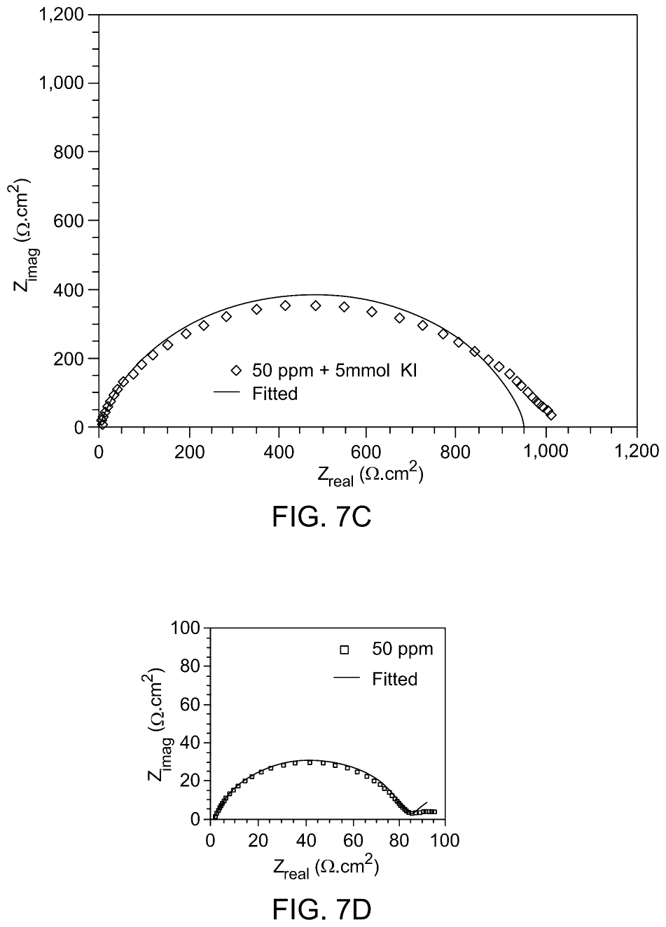

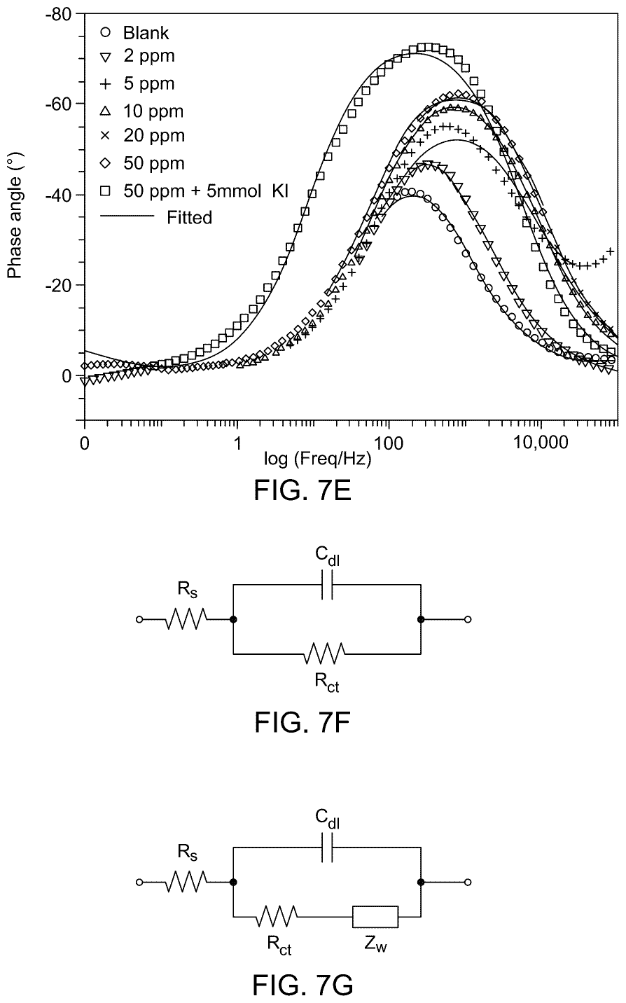

The EIS technique allows for analyzing the characteristics and dynamics of electrochemical reactions occurring on the metal surface in an acid solution. EIS is a commonly utilized approach to comprehend the mechanisms of corrosion, passivation, and charge transfer at the metal/electrolyte interface. FIG. 7A displays Nyquist curves for C1018 CS corrosion in 15% HCl with and without PMDAAC and PMDAAC+5 mM KI. The C1018 CS corrosion in 15% HCl is caused by a single charge transfer mechanism, which was seen as a single semicircle of Nyquist curves both in the absence and presence of PMDAAC and PMDAAC+5 mM KI. In all cases, a single maximum in the Bode plots (FIG. 7B and FIG. 7E) supported the idea of a single charge transfer process. The Nyquist curve's diameter serves as a gauge of the charge transfer process's resistance, and a large Nyquist curve diameter is linked to both high resistance and corrosion protection. The mass transfer mechanisms, frequency dispersion, inhomogeneities, and roughness of the metal surface are all attributed to the defective semicircle of the impedance spectrum. With increasing PMDAAC concentrations, the incomplete semicircles' diameters increase. This result supports that the PMDAAC under study strongly aggregates on the surface of C1018 CS, blocks the active sites, and increases charge transfer resistance and effectiveness of inhibition.

Equivalent circuits presented in FIG. 7F and FIG. 7G were used to fit and analyze the Nyquist data for C1018 CS corrosion in 15% HCl. Instead of using pure double-layer capacitance (C_{dl}) in this instance, a controlled potential electrolysis (CPE) was employed to account for the surface heterogeneities and roughness of C1018 CS, impurities, the creation of porous layers, dislocations, the adsorption of inhibitors, and grain boundaries. The impedance nature of CPE (Z_{CPE}) can be expressed by equations (9) and (10):

$${Z}_{CPE} = {( \frac{1}{{Y}_{0}} ) [ {( j ω )}_{n} ]}^{- 1} \qquad ( 9 )$$

$${C}_{dl} = {{Y}_{0} ( {ω}_{max} )}^{n - 1} \qquad ( 10 )$$

where n is the phase shift, j is the imaginary number, Y₀ is the CPE constant, and ω is the angular frequency (exponent). The n value gives a measurement of surface inhomogeneity brought on by the adsorption of PMDAAC, the creation of porous films, surface roughness, and the like. CPE can represent resistance (n=0), capacitance (n=1), inductance (n=1), or Warburg impedance (n=0.5) depending on the value of n.

Table 6 displays the various EIS parameters. Upon closer examination of the data, it is seen that Ret values increase, while the values of Ca decrease in the presence of PMDAAC and PMDAAC+5 mM KI. This implies the PMDAAC becomes effective by imposing a barrier on the charge transfer process through their adsorption, which builds the corrosion-protecting coating. These effects were more prominent at higher PMDAAC concentrations, especially in the presence of 5 mM KI.

TABLE 6
EIS parameters for C1018 CS corrosion in 15% HCl in the absence and presence
of PMDAAC and PMDAAC + 5 mM KI at 30° C.

| | | | | | | | | | The |
|---|---|---|---|---|---|---|---|---|---|
| | Conc. | Rₛ | R_{ct} | | C_{dl} | Z_{w} | | | goodness of |
| Sample | (ppm) | (Ω cm²) | (Ω cm²) | n | (μF cm⁻²) | (Ω cm²) | % IE | θ | fit (×10⁻³) |
| | 0 | 1.15 | 13.12 | 0.799 | 168.78 | — | — | — | 1.33 |
| | 2 | 5.41 | 39.41 | 0.789 | 76.15 | 0.9747 | 66.71 | 0.6671 | 0.42 |
| | 5 | 1.19 | 50.63 | 0.746 | 52.24 | 0.8230 | 74.09 | 0.7409 | 7.11 |
| PMDAAC | 10 | 1.01 | 54.33 | 0.816 | 49.35 | 0.5018 | 75.85 | 0.7585 | 0.34 |
| | 20 | 1.07 | 71.47 | 0.822 | 38.19 | 0.3664 | 81.64 | 0.8164 | 0.41 |
| | 50 | 1.04 | 78.48 | 0.820 | 39.79 | 0.3162 | 83.28 | 0.8328 | 0.55 |
| | 50 + 5 | 3.71 | 829.40 | 0.884 | 18.55 | — | 98.42 | 0.9842 | 2.95 |
| | mM KI | | | | | | | | |

### Surface Studies

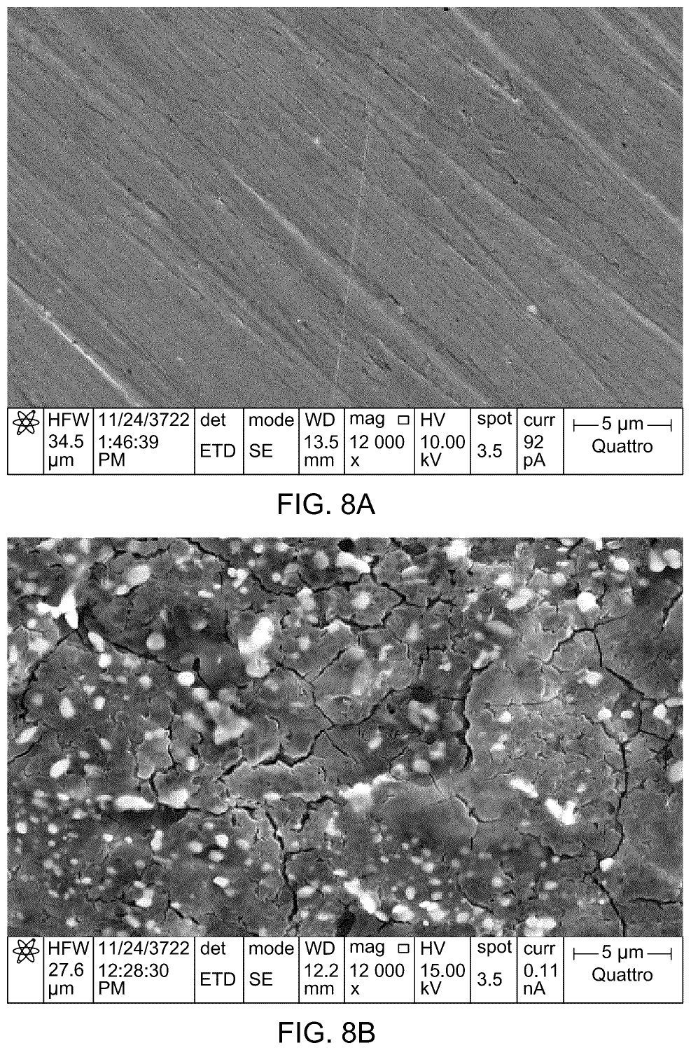

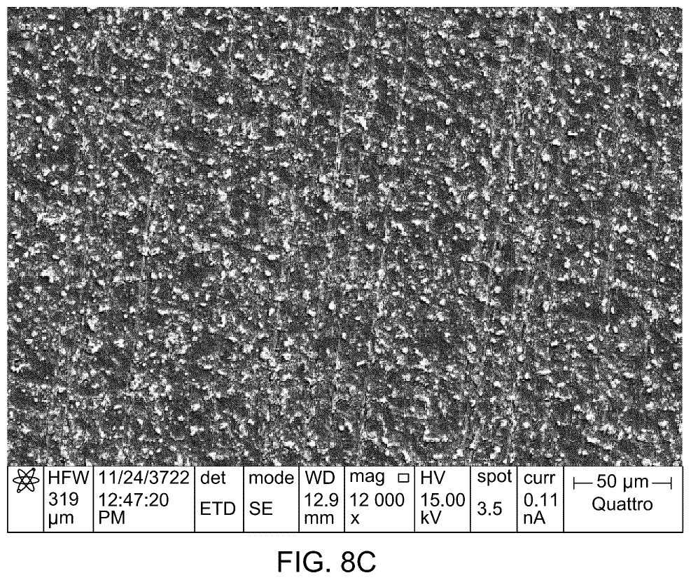

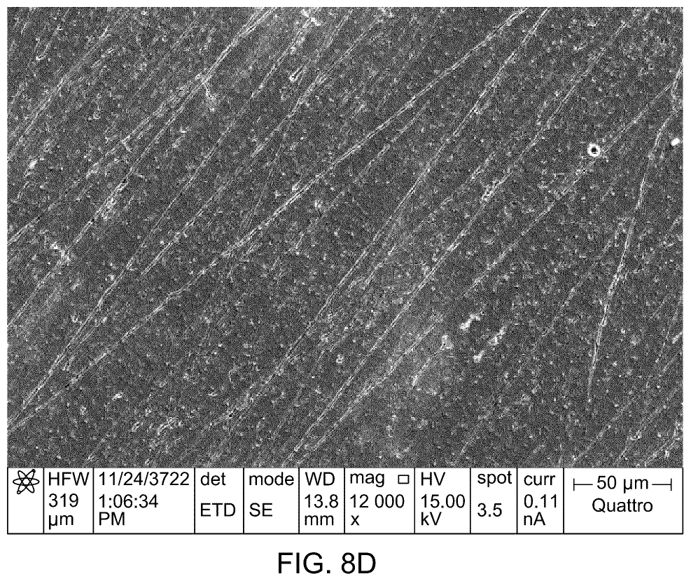

SEM-EDX, a scanning electron microscope coupled with energy-dispersive X-ray, is one of the primary methods for inspecting and evaluating the elemental surface components of corrosion-related materials. While EDX is utilized for elemental analysis, the SEM inspection explicitly provides information about the steel surface concerning the morphology and kind of corrosion. The relationship between surface morphology and the relative corrosion inhibition potential of PMDAAC and PMDAAC+5 mM KI has been established. Due to the aggressiveness of the test electrolyte, it is evident that metallic surfaces should corrode and damage easily without any inhibitors. But if there are inhibitors in the electrolyte, the inhibitors should adsorb and shield the metallic surface from corrosive damage. Compared to unprotected surfaces, metallic surfaces with inhibitors are anticipated to have a smoother surface. FIG. 8A, reveals that the polished metal surface is largely smooth and uniform, with a few abrading and polishing scratches. The C1018 CS surface, on the other hand, is severely corroded and degraded with pits, cracks, and broad scratches after being exposed to 15% HCl without PMDAAC (FIG. 8B). The surfaces of the C1018 CS (FIG. 8C and FIG. 8D), however, became smoother in the presence of PMDAAC and PMDAAC+5 mM KI as a result of the protective coating that the inhibitor produced. SEM images of polished C1018 CS (FIG. 8A) and protected C1018 CS by PMDAAC+5 mM KI (FIG. 8D) have comparable morphologies.

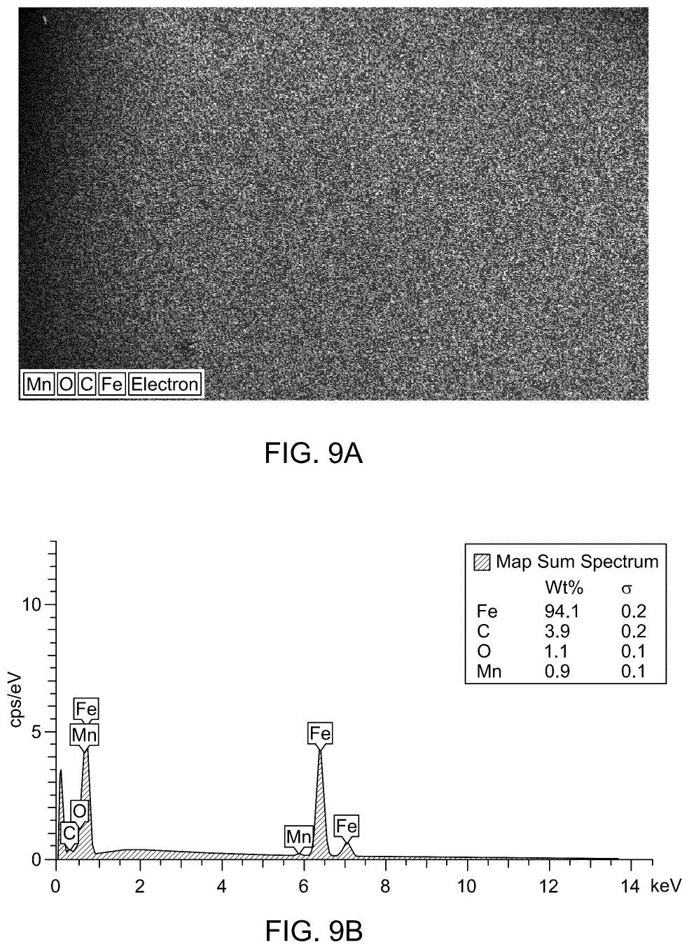

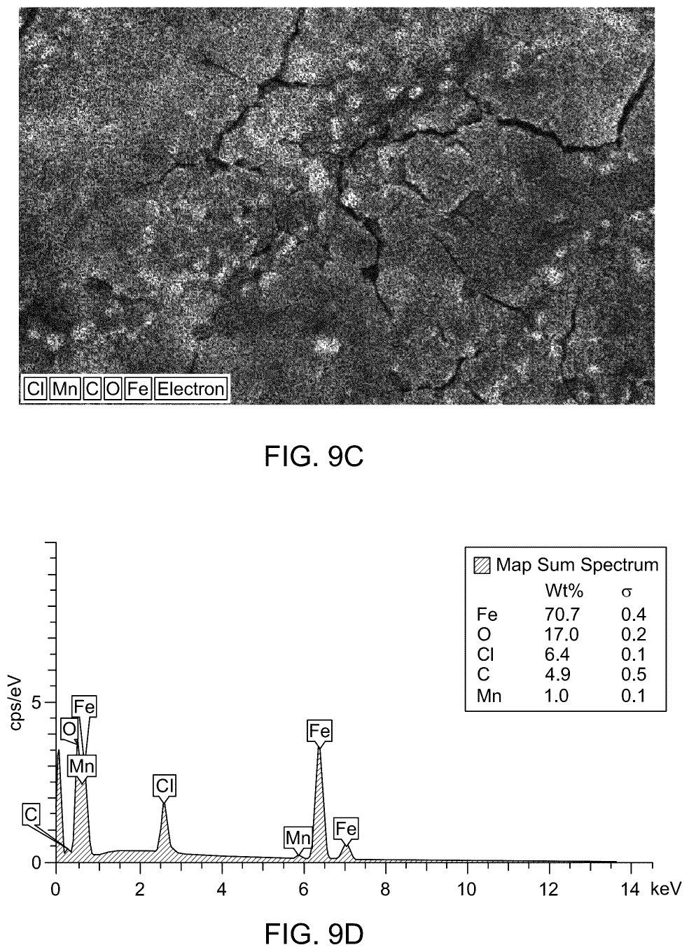

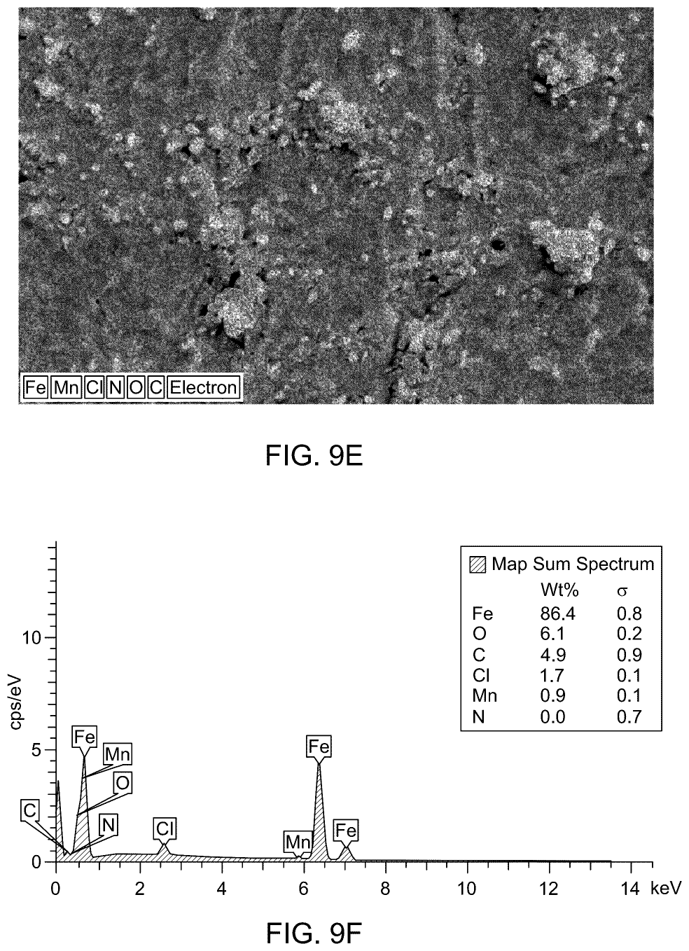

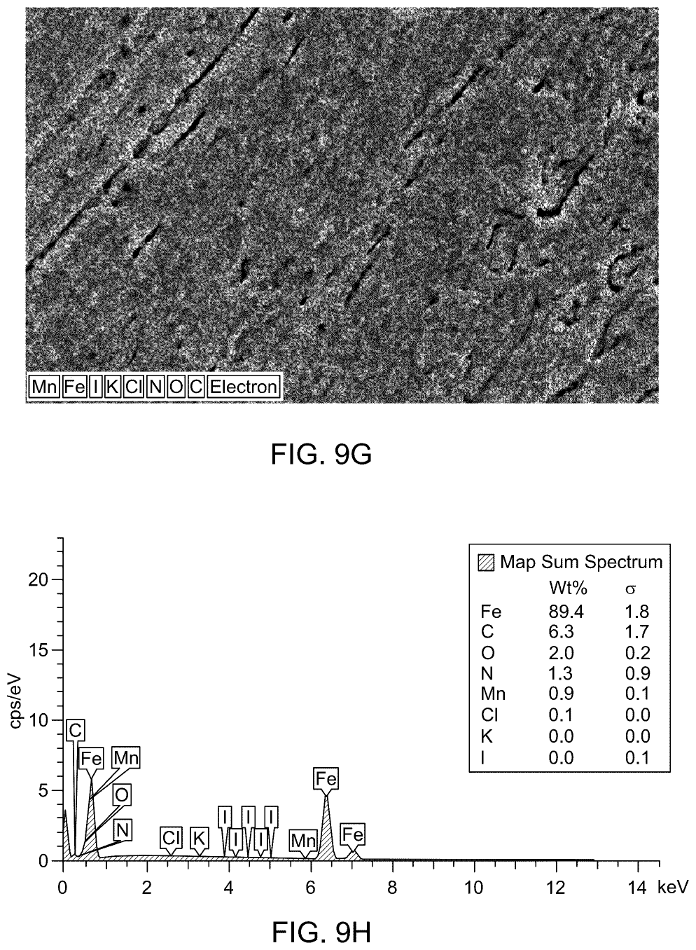

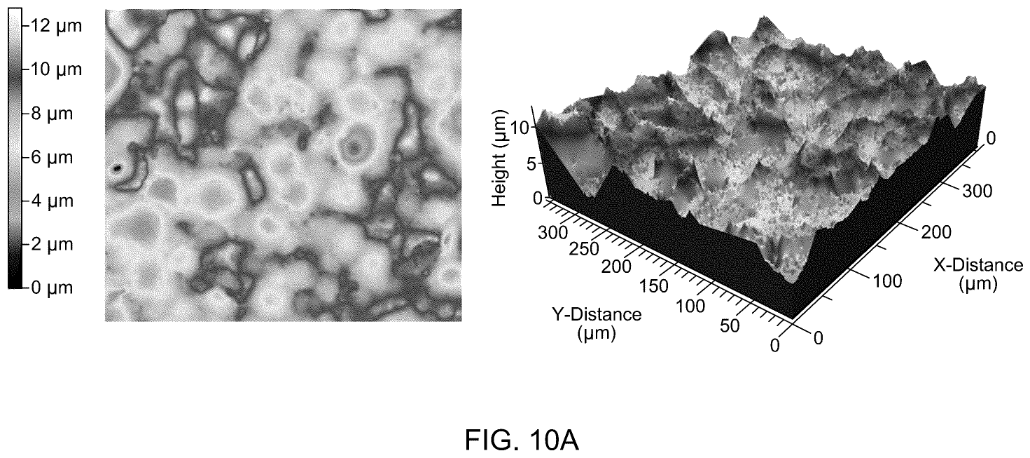

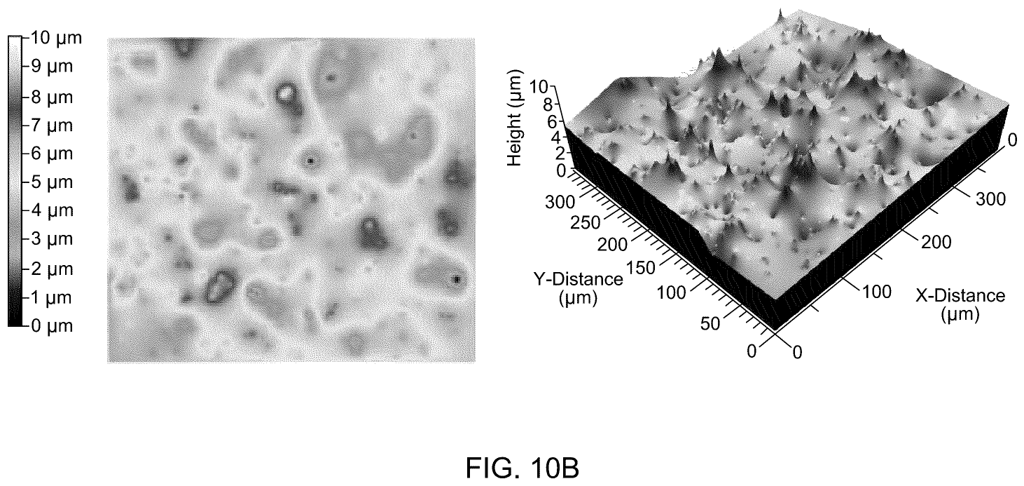

The EDX tests, which looked at the components on the polished and corroded metallic surface in the presence and absence of PMDAAC and PMDAAC+5 mM KI, further supported the adsorption method of corrosion prevention. FIGS. 9A-9H show the EDX spectra and elemental mapping of various samples. On the polished metal surface, only C (3.9%), O (1.1%), Mn (0.9%), and Fe (94.1%) are visible. In the presence of PMDAAC and PMDAAC+5 mM KI, the EDX spectrum of a corroded metal surface exhibits an extra signal for chloride that results from the electrolyte. More so, the percentage composition of surface elements is changed as the composition of Fe reduced, and other elements increased. The EDX spectrum of the C1018 CS surface corroded in the presence of PMDAAC reveals an additional peak for nitrogen (N) that derives from PMDAAC. This finding suggests the PMDAAC adsorbs on the metal surface and protects it from aggressive attacks. The presence of a peak for iodine in the EDX spectrum of the C1018 CS surface inhibited by PMDAAC+5 mM KI results from the adsorption of iodide ions on the metallic surface.

Atomic force microscopy (AFM) is an analytical technique for determining local properties, such as the topography of grains, metallic, ceramic, polymer, and organic or inorganic composite surfaces. AFM has been used to characterize the surface phenomena of metals in various corrosive fluids (in-situ and/or ex-situ). There are multiple benefits to using AFM for surface examination over conventional methods [K. W. Shinato et. al., Principle and application of atomic force microscopy (AFM) for nanoscale investigation of metal corrosion, Corrosion Reviews, 38 (2020) 423-432, incorporated herein by reference in its entirety] such as: (i) AFM can be carried out in a variety of settings, including ambient, liquid, and vacuum, due to its capability to image in a liquid environment, it is ideally suited for the study of biological materials; (ii) SEM can only be used with conducting samples; therefore, a non-conductive sample must be covered in metal to enable imaging which would permanently alter or harm the sample, and with AFM this additional sample preparation labor is not required; (iii) unlike SEM, which can only image in two dimensions, AFM can create a three-dimensional image of a sample surface by quantifying the surface roughness; (iv) compared to 2D TEM, 3D AFM images can be obtained for less money, provide more information, and are more detailed.

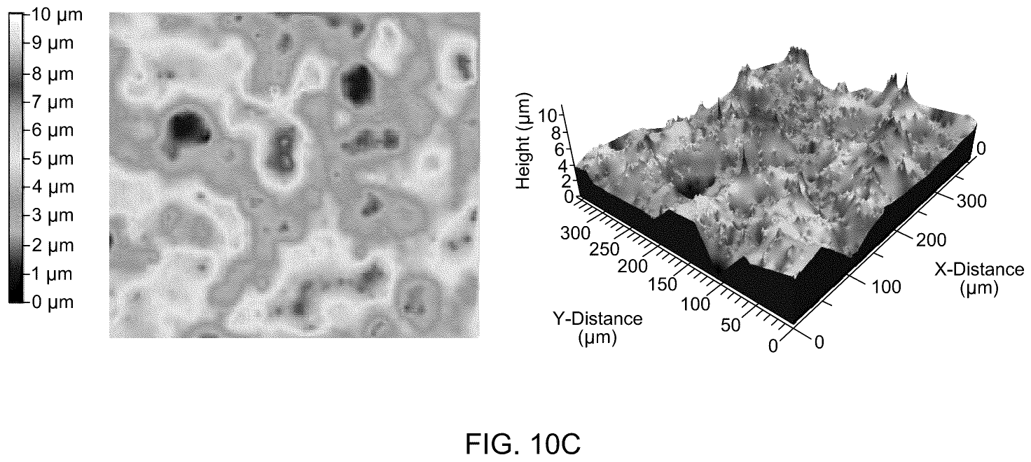

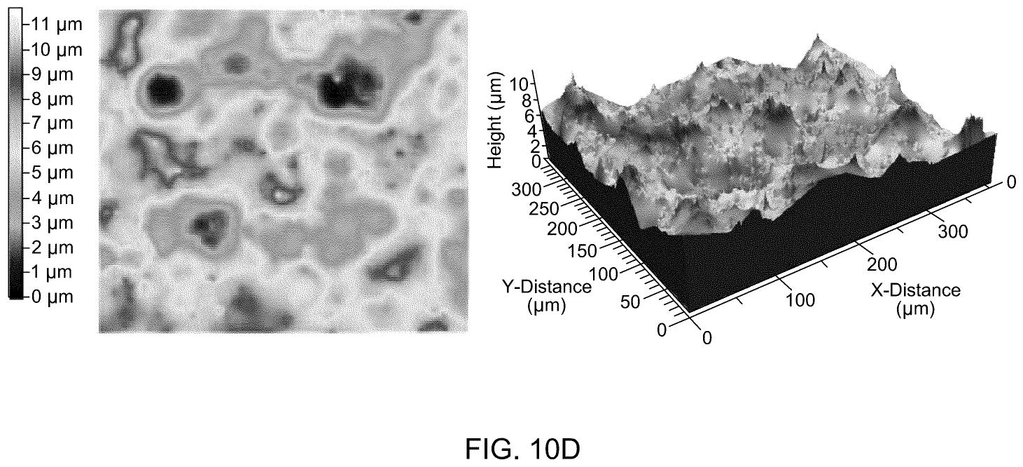

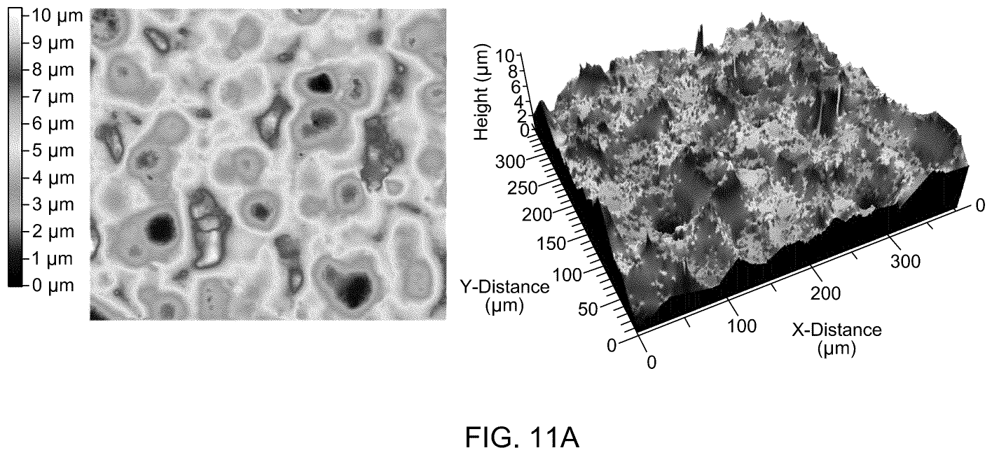

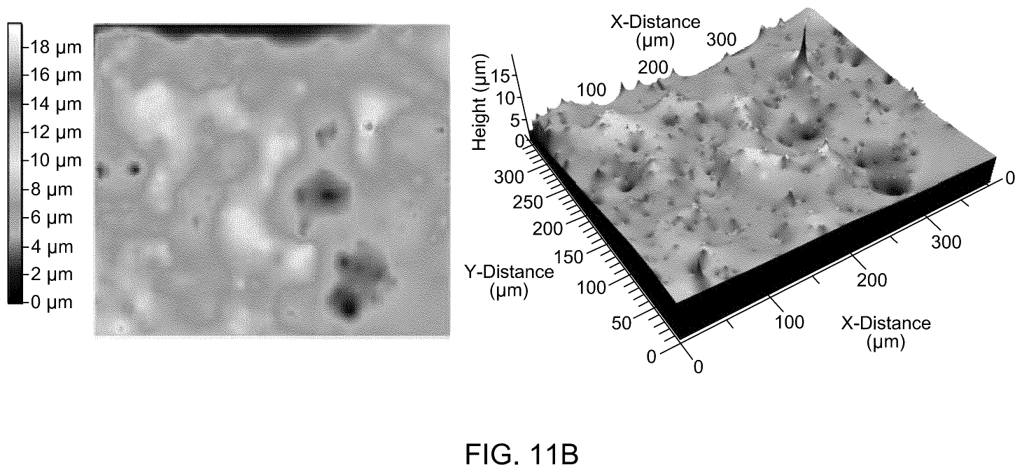

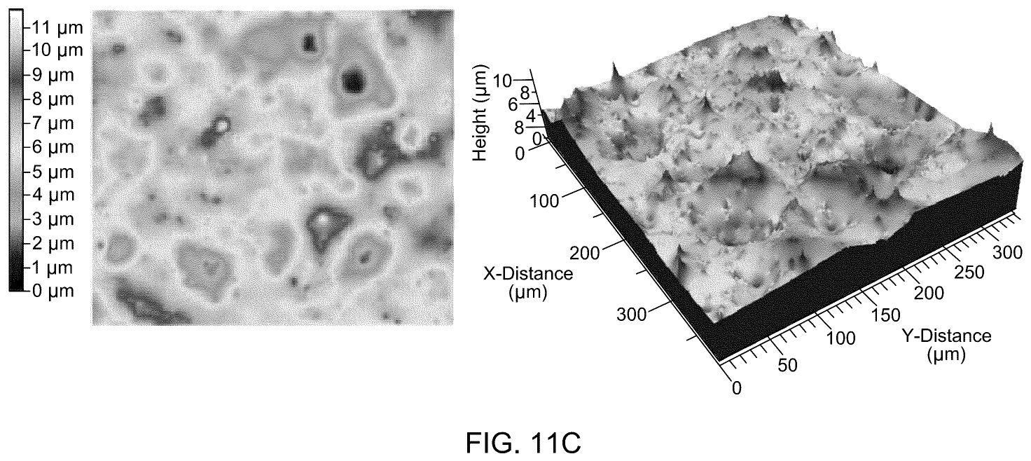

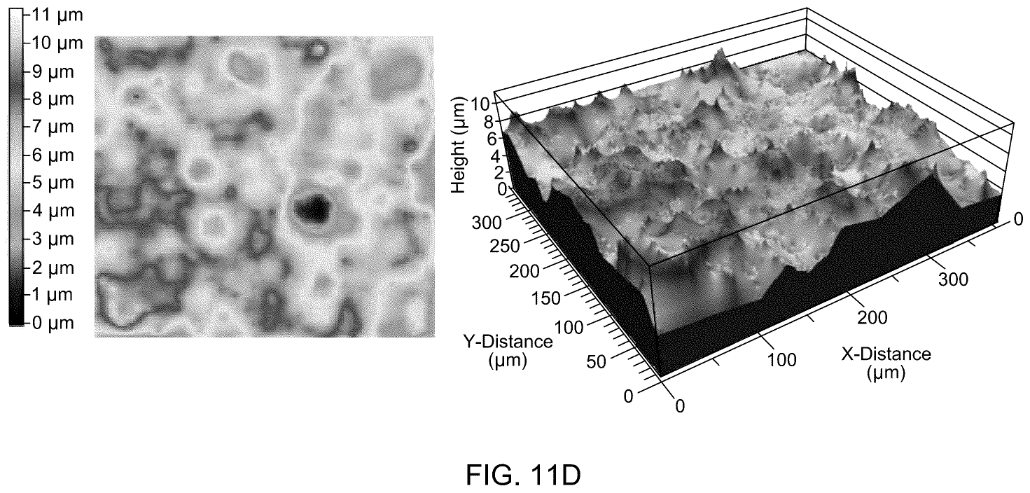

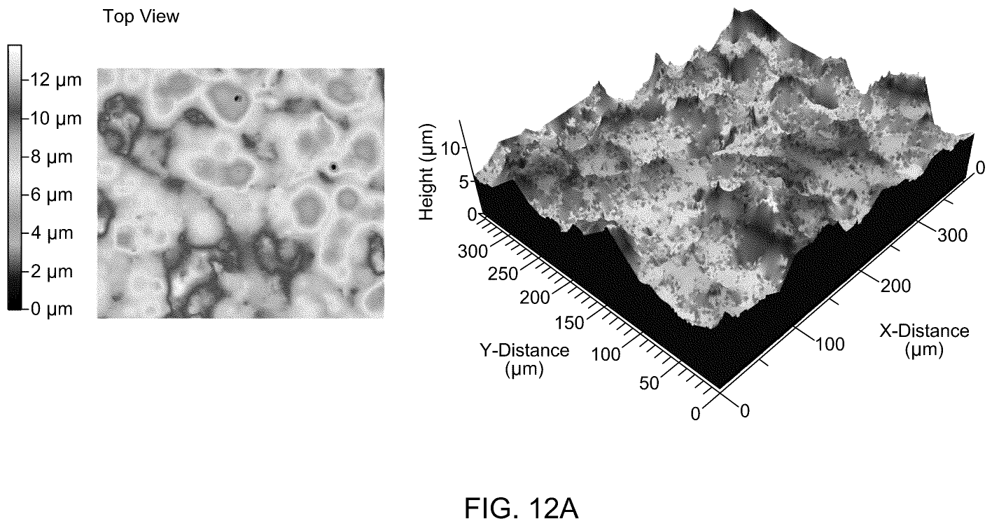

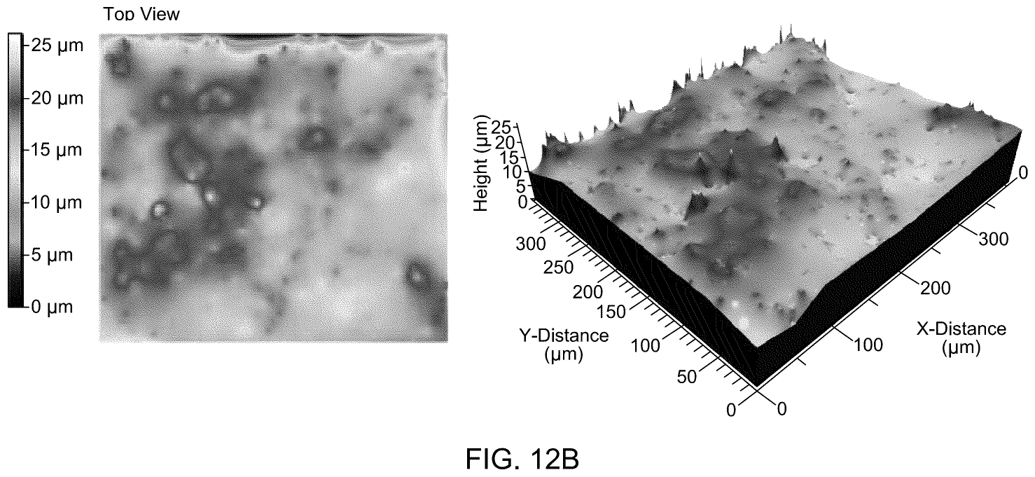

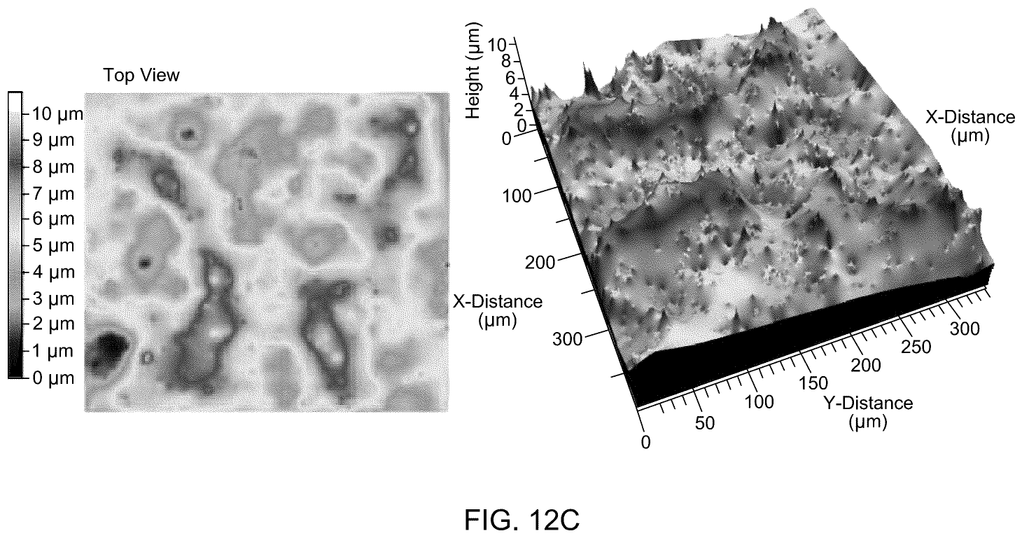

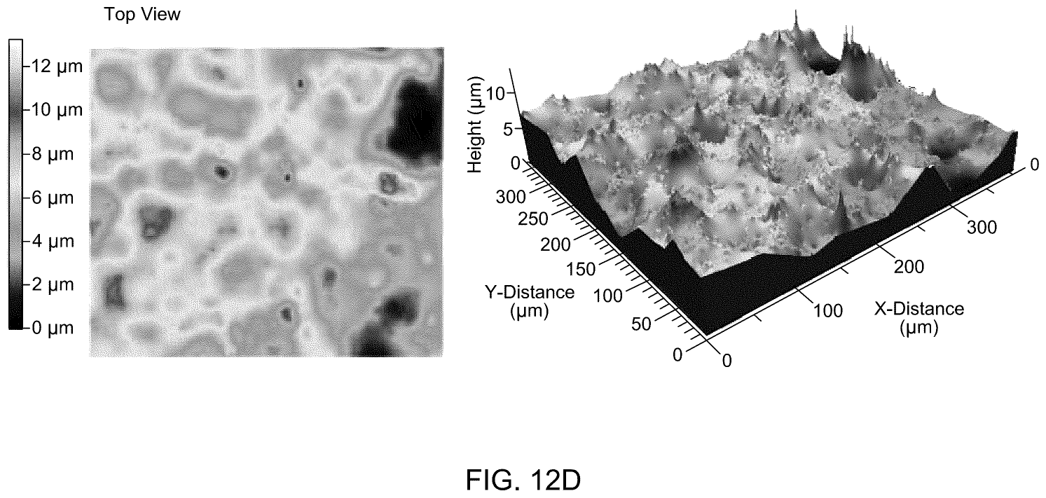

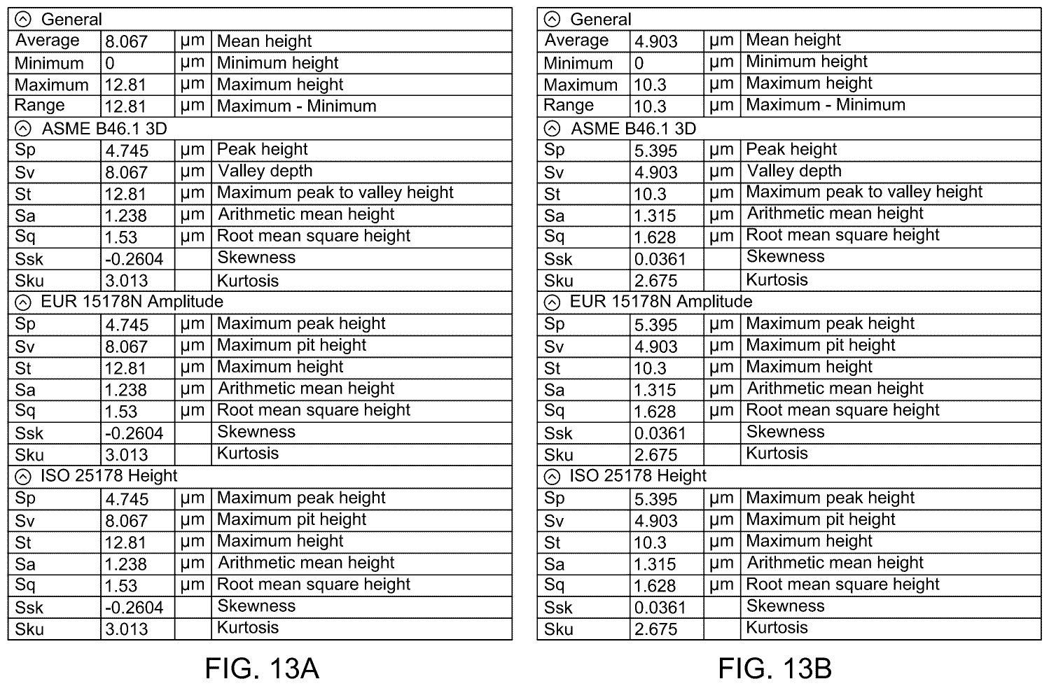

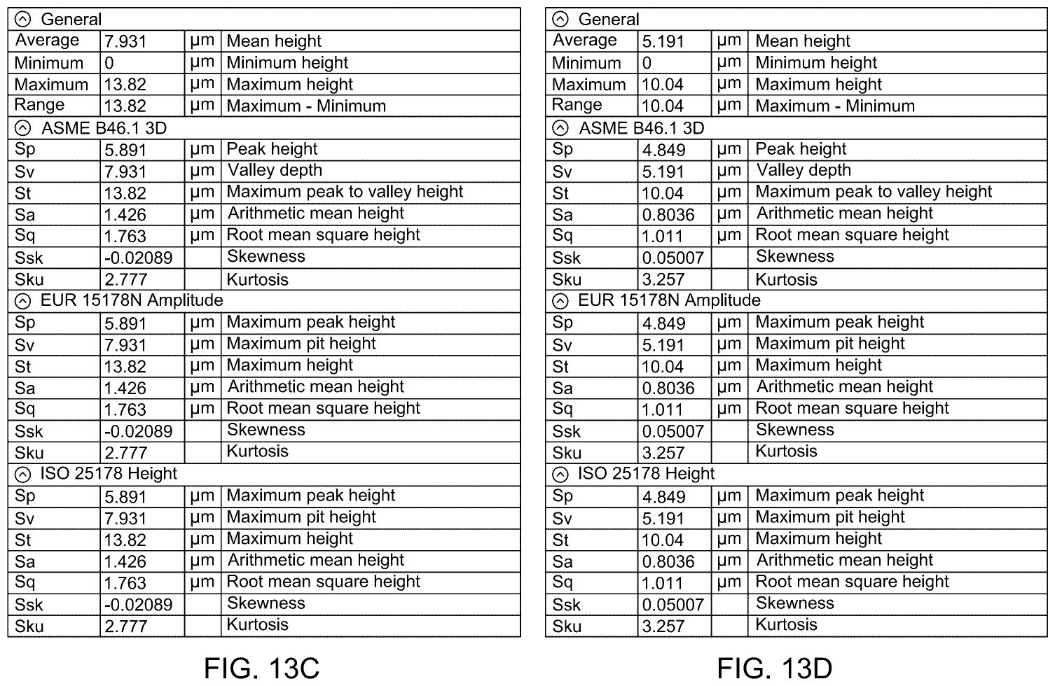

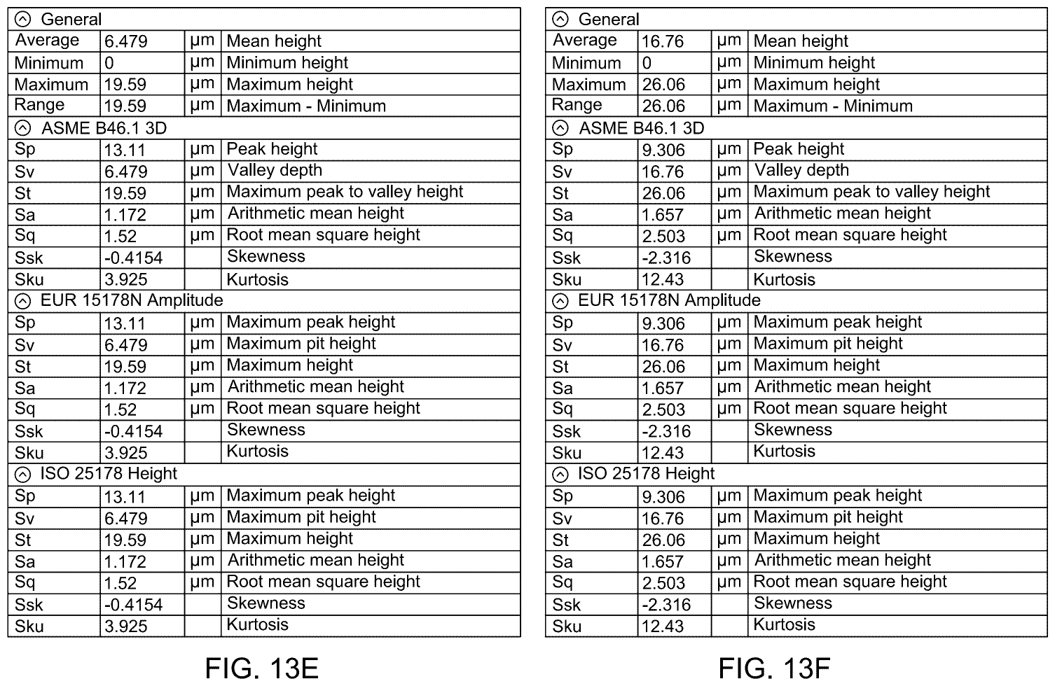

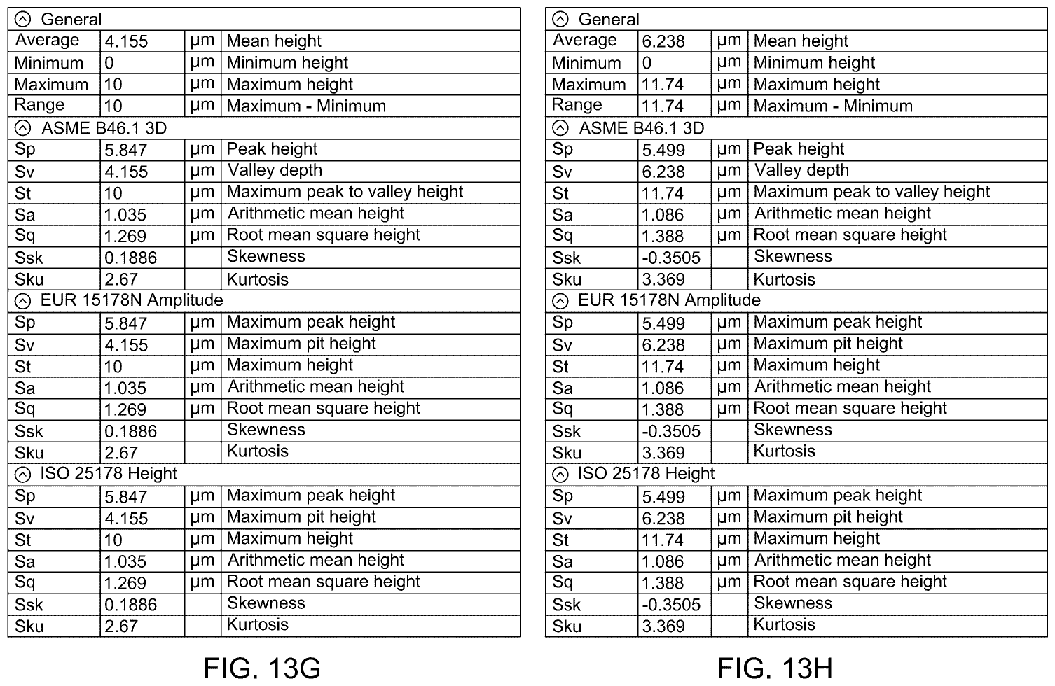

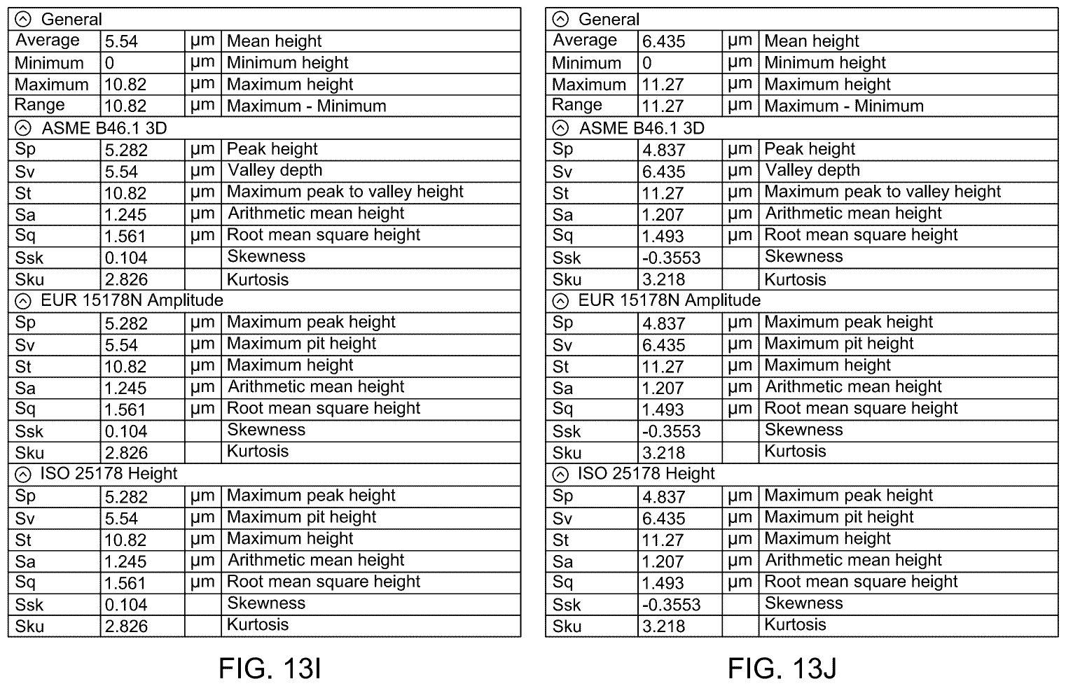

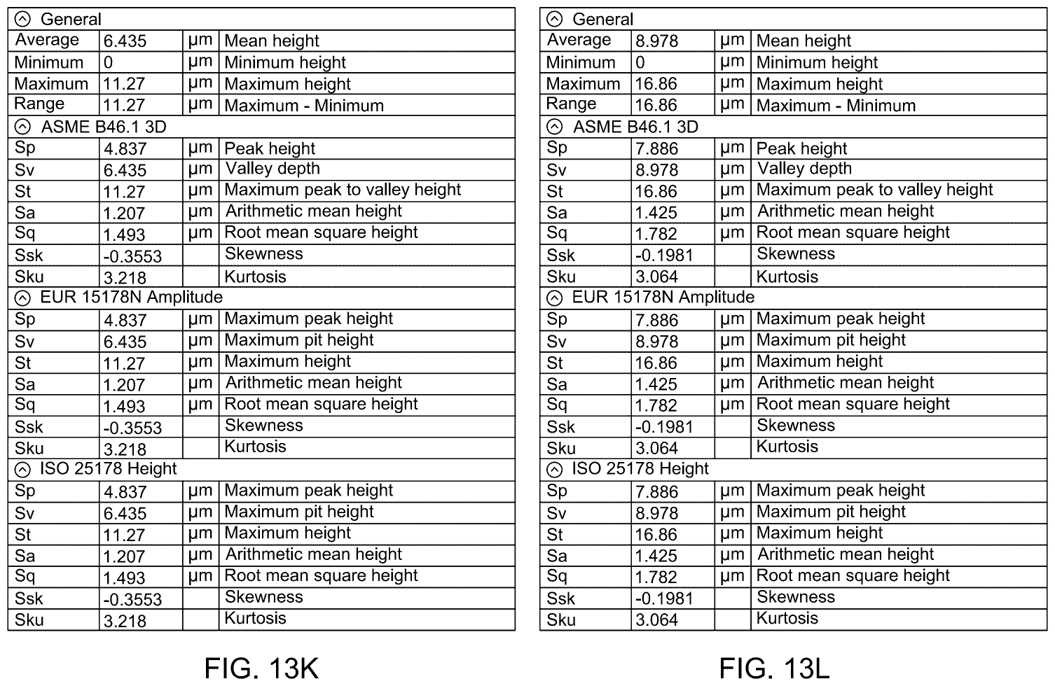

The AFM technique is frequently utilized to characterize corrosion mitigation adsorption mechanisms and support the gravimetric and electrochemical outcomes of studies on corrosion inhibition. A metallic surface exposed to a corrosive environment should corrode and suffer damage from free electrolyte assaults; however, surface degradation and roughness are anticipated to lessen if a corrosion inhibitor shields the surface. FIGS. 10A-10D and FIGS. 11A-11D display the two sets of 2D and 3D pictures of specimens that have been polished, corroded, and protected with PMDAAC with and without 5 mM KI. The third set of AFM images and other relevant AFM data are presented in FIGS. 12A-12D. Tabulate data parameters of the three sets of 2D and 3D AFM are shown in FIGS. 13A-13L. Three images were captured for each specimen, and their average surface roughness (ASR) was presented. It is shown from this data that the polished surface of C1018 CS is relatively smooth and has an average surface roughness (ASR) of 6.967 μm. The C1018 CS surface after exposed to 15% HCl, on the other hand, is somewhat more degraded and corroded, having an ASR of 9.476 μm. This may be attributable to free acid attacks in the absence of any inhibitor.

Nevertheless, the surface morphologies improved in the presence of PMDAAC at 50 ppm with and without 5 mM KI. The ASR of C1018 CS specimens protected by PMDAAC (50 ppm) and PMDAAC (50 ppm)+5 mM KI were 5.311 and 5.912 μm, respectively. The increased surface smoothness in the presence of PMDAAC (50 ppm) and PMDAAC (50 ppm)+5 mM KI may be attributed to their protective film formation. The presence of KI causes a slight increase in the ASR, which may be attributed to the formation and accumulation of ferrous and ferric iodine on the metal surface.

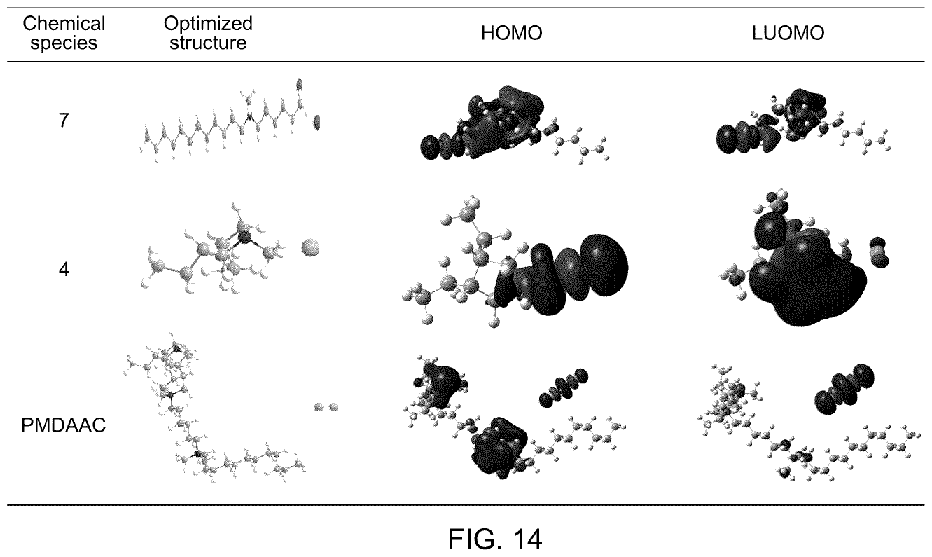

FIG. 14 displays the frontier molecular orbital (FMO) images of PMDAAC and its constituent parts. A close examination reveals that the quaternary nitrogen and bromohexyl moiety are where most of the highest occupied molecular orbital (HOMO) and lowest occupied molecular orbital LUMO (7), or a charge transfer capacity and a charge accepting capacity, respectively, are primarily situated. This result implies that the bromohexyl segment of 7 and the quaternary nitrogen play a large role in charge sharing with the metallic surface. Notably, charge-sharing, including donation and retrodonation, is involved in the interactions of organic molecules with the metal surface in aqueous solutions. In 4, the pyrrolidinium moiety is localized by the HOMO and LUMO, demonstrating that ring counterions, like nitrogen and chloride, contributed to bonding with the metallic surface despite the compound's positive charge. The analysis of FMOs for segment PMDAAC reveals that the HOMO and LUMO are distributed over the pyrrolidinium's nitrogen and chloride ions (4), quaternary nitrogen, and bromohexyl moieties (7), validating that these segments take part in the bonding and charge sharing with the iron surface. The remaining segments of PMDAAC behave as a water-repellent by forming a hydrophobic film.

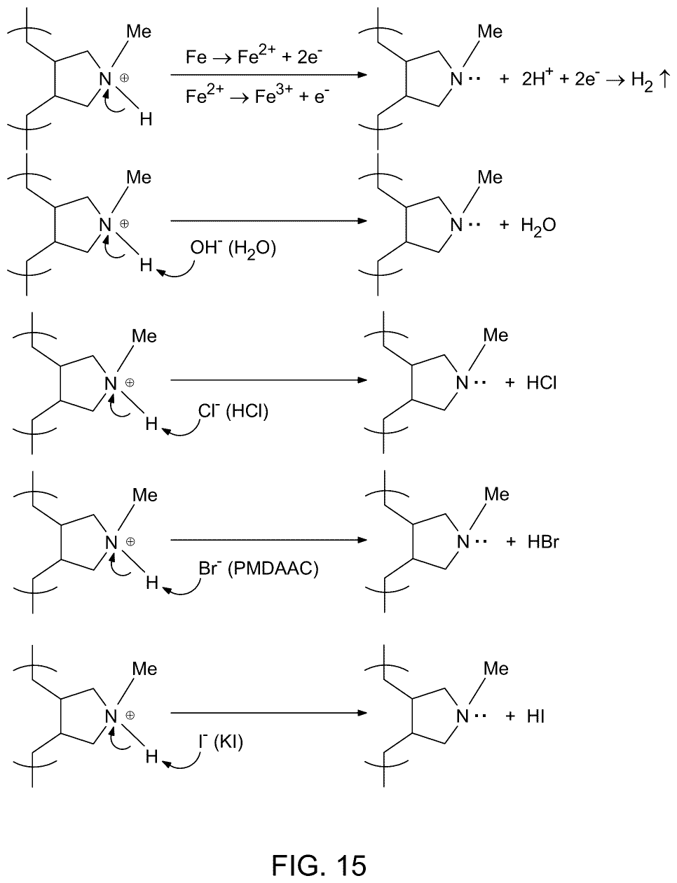

In charge sharing with the metallic surface, pyrrolidinium's nitrogen, chloride ions, quaternary nitrogen, and bromohexyl moieties play a large role, as can be shown by the chemical structure and FMOs (HOMO and LUMO) of PMDAAC. PMDAAC contains three types of nitrogen atoms, and none of the nitrogen atoms possess their shared electron pairs. In this instance, chemisorption has a lower probability of occurring; however, thermodynamic analyses demonstrate that PMDAAC is adsorbed through a chemisorption method because the AG ads value is higher than −40 KJ mol⁻¹ (−43.76 kJ mol⁻¹). Additionally, the activation energy for C1018 CS corrosion in the test electrolyte decreased in the presence of PMDAAC, supporting the chemisorption mode. Based on this, it can be supported that even though physisorption may be the initial stage of interaction between PMDAAC and metallic surfaces, chemisorption is the primary mechanism of interaction. This could be possible by deprotonation of the pyrrolidinium's nitrogen having one hydrogen by intake of electrons released by oxidation of Fe to Fe²⁺ and/or Fe²⁺ to Fe³⁺, specifically in the situation where PMDAAC molecules are present near a metal surface. More so, counter ions such as the chloride, bromide, and hydroxide ions of HCl, H₂O, and PMDAAC can assist in the deprotonation of pyrrolidinium's nitrogen through the following mechanisms (FIG. 15). Potassium iodine may also promote deprotonation by causing the liberation of HI (hydrogen iodide) and KOH (potassium hydroxide).

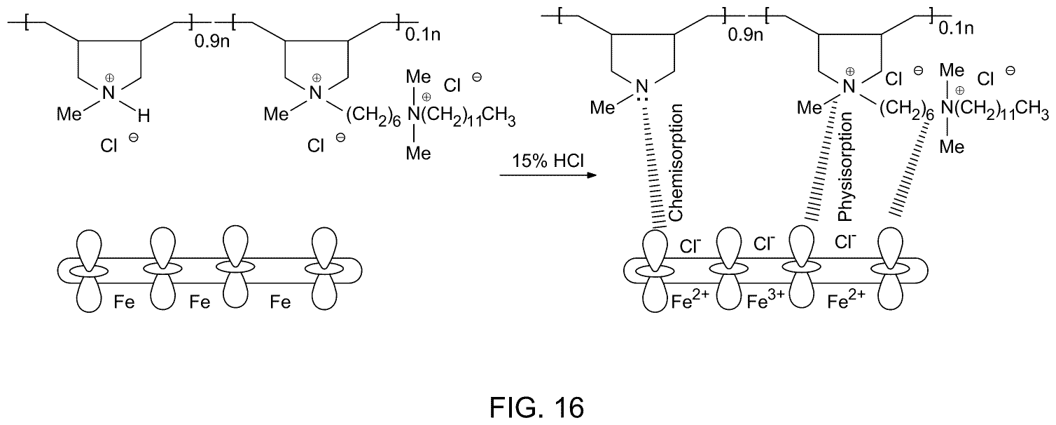

Therefore, it is conceivable that the pyrrolidinium moiety, which has a hydrogen bonded to a quaternary nitrogen, interacts with the surface of C1018 CS via chemisorption, while the two other quaternary nitrogen atoms, where deprotonation is impossible, interact via physisorption. The neutral nitrogen atoms transfer their non-bonding electrons in metallic d-orbitals with their free unshared electron pairs. Typically, this practice is referred to as a donation or transfer. The inter-electronic repulsion is noticeably increased by this transfer, which forces metals to transfer their excess electrons into unoccupied PMDAAC p-orbitals. “Back donation” or “pi backbonding” refers to this procedure. Naturally, donation and back donation complement one another. The bonding and adsorption mode of PMDAAC on the C1018 CS surface in a 15% HCl solution is illustrated in FIG. 16.

To summarize, the efficacy of PMDAAC dicationic surfactant to prevent corrosion of C1018 CS in a 15% HCl (acidizing) solution was studied. According to weight loss studies, PMDAAC has a nominal capacity to hinder the C1018 CS/15% HCl system, as evidenced by its inhibition efficiency (% IE) of 76.57% at 50 ppm concentration. At the desired concentration (50 ppm), adding 5 mM KI further increases the % IE of PMDAAC from 76.57% to 95.26% based on an initial weight of the C1018 CS. Research on weight loss and electrochemical processes suggests that PMDAAC works by adhering to metallic surfaces. The Langmuir adsorption isotherm was followed during the adsorption of PMDAAC. Based on the PDP study, PMDAAC operates as a mixed-type inhibitor and can delay both anodic and cathodic reactions without appreciably altering the corrosion potential. SEM, in conjunction with EDX investigations, provided evidence for the adsorption mechanism of corrosion mitigation. AFM studies supported the adsorption of PMDAAC onto the C1018 CS surface. The change in chemical composition and improvement in surface morphology in the presence of PMDAAC support the adsorption mode of corrosion mitigation. DFT investigation suggested that PMDAAC interacts with the metallic surface effectively due to its structural constituents.

Numerous modifications and variations of the present disclosure are possible in light of the above teachings. It is, therefore, to be understood that, within the scope of the appended claims, the invention may be practiced otherwise than as specifically described herein.

1: A corrosion inhibitor composition, comprising:
a polycationic polymeric surfactant,
wherein the polycationic polymeric surfactant is a copolymer comprising polymerized units of cationic heterocyclic monomer units and dicationic heterocyclic comonomer units comprising a quaternary ammonium group,
wherein the cationic heterocyclic monomer and the dicationic heterocyclic comonomer are alkyl diallyl ammonium units;
wherein the quaternary ammonium group comprises a first C8-C16 alkyl group, a second C4-C8 alkyl group, a third C1-C2 alkyl group, and a fourth C1-C2 alkyl group.

2: The corrosion inhibitor of claim 1, wherein the cationic heterocyclic monomer and the dicationic heterocyclic comonomer units are present in the polymer in a molar ratio in a range of 0.85:0.15 to 0.95:0.05.

3: The corrosion inhibitor of claim 1, wherein the quaternary ammonium group is a dodecyl-dimethyl-hexyl ammonium chloride.

4: The corrosion inhibitor of claim 1, wherein the polycationic polymeric surfactant has a repeating structure: 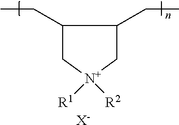
wherein R¹ is a methyl group,
wherein R² is a hydrogen atom or the quaternary ammonium group, and
wherein X is a chloride atom.

5: A method of corrosion inhibition, comprising:
contacting a metal substrate with the corrosion inhibitor of claim 1,
wherein the corrosion inhibitor is in the form of a solution comprising the polycationic polymeric surfactant in an amount of 1 to 60 parts per million (ppm) and an acidic aqueous electrolyte to form a corrosion inhibitor coated metal substrate.

6: The method of claim 5, wherein the polycationic polymeric surfactant is in an amount of 5 to 60 ppm and wherein the corrosion inhibitor coated metal substrate has an inhibition efficiency of 65 to 80% based on weight loss of the metal substrate.

7: The method of claim 5, wherein the polycationic polymeric surfactant is in an amount of 5 to 60 ppm and wherein the corrosion inhibitor coated metal substrate has a corrosion rate of 4 to 6 mm yr⁻¹ compared to a corrosion rate of 17 to 19 mm yr⁻¹ of the metal substrate in the absence of the corrosion inhibitor.

8: The method of claim 5, wherein the polycationic polymeric surfactant adsorbs on a surface of the metal substrate via chemisorption.

9: The method of claim 5, wherein the polycation polymeric surfactant is in an amount of 40 to 60 ppm and wherein the corrosion inhibitor coated metal substrate has a corrosion current density of 350 to 450 microamperes per square centimeter (μA cm⁻²) compared to a corrosion current density of 2600 to 2800 A cm⁻² of the metal substrate in the absence of the corrosion inhibitor.

10: The method of claim 5, wherein the polycation polymeric surfactant is in an amount of 40 to 60 ppm and wherein the corrosion inhibitor coated metal substrate has an elemental composition of iron in the amount of 85 to 88% by weight, oxygen in the amount of 5 to 7% by weight, carbon in the amount of 4 to 6% by weight, chlorine in the amount of 1 to 3% by weight, and manganese 0.5 to 1.5% by weight based on a total weight of the corrosion inhibitor coated metal substrate.

11: The method of claim 5, wherein the polycation polymeric surfactant is in an amount of 40 to 60 ppm and wherein the corrosion inhibitor coated metal substrate has an average surface roughness of 5 to 5.5 micrometers (μm).

12: The method of claim 5, further comprising:
adding potassium iodide to the solution.

13: The method of claim 12, wherein the polycationic polymeric surfactant is in an amount of 40 to 60 ppm, wherein a concentration of potassium iodide is 4 to 6 millimolar (mM), and wherein the corrosion inhibitor coated metal substrate has an inhibition efficiency of 92 to 97% based on weight loss of the metal substrate.

14: The method of claim 12, wherein the polycationic polymeric surfactant is in an amount of 40 to 60 ppm, wherein a concentration of potassium iodide is 4 to 6 mM, and wherein the corrosion inhibitor coated metal substrate has a corrosion rate of 0.5 mm yr⁻¹ to 1 mm yr⁻¹ compared to a corrosion rate of 17 to 19 mm yr⁻¹ of the metal substrate in the absence of the corrosion inhibitor and potassium iodide.

15: The method of claim 12, wherein the polycationic polymeric surfactant adsorbs on a surface of the metal substrate using physisorption.

16: The method of claim 12, wherein the polycation polymeric surfactant is in an amount of 40 to 60 ppm, wherein a concentration of potassium iodide is 4 to 6 mM, and wherein the corrosion inhibitor coated metal substrate has a corrosion current density of 15 to 25 μA cm⁻² compared to a corrosion current density of 2600 to 2800 μA cm⁻² of the metal substrate in the absence of the corrosion inhibitor and potassium iodide.

17: The method of claim 12, wherein the polycation polymeric surfactant is in an amount of 40 to 60 ppm, wherein a concentration of potassium iodide is 4 to 6 mM, and wherein the corrosion inhibitor coated metal substrate has an elemental composition of iron in the amount of 88 to 91% by weight, oxygen in the amount of 1 to 3% by weight, carbon in the amount of 5 to 7% by weight, chlorine in the amount of 0.01 to 0.5% by weight, manganese 0.5 to 1.5% by weight, and nitrogen in the amount of 0.5 to 2% by weight based on a total weight of the corrosion inhibitor coated metal substrate.

18: The method of claim 12, wherein the polycation polymeric surfactant is in an amount of 40 to 60 ppm, wherein a concentration of potassium iodide is 4 to 6 mM, and wherein the corrosion inhibitor coated metal substrate has an average surface roughness of 5.5 to 6 μm.

19: The method of claim 5, wherein the metal substrate is C1018 carbon steel.

20: The method of claim 5, wherein the acidic aqueous electrolyte is hydrochloric acid in a concentration of 10 to 20 percent by weight.
